(19) United States
(12) Patent Application Publication
(10) Pub. No.: US 2025/0259811 A1
(43) Pub. Date: Aug. 14, 2025

(54) ALTERNATING RELAYS FOR EXTENDED LIFE OF RELAYS

(71) Applicant: Webasto Charging Systems, Inc., Monrovia, CA (US)

(72) Inventor: Michael Joseph Johnson, Monrovia, CA (US)

(21) Appl. No.: 18/437,107

(22) Filed: Feb. 8, 2024

(51) Int. Cl. H01H 47/00

(52) U.S. Cl. CPC H01H 47/001; H01H 2231/026; H01H 2300/052

(57) ABSTRACT

A system and method for including a processor having addressable memory, the processor in communication with two or more relays, where the processor is configured to: store a first state based on an order of two or more relays to be switched on; send one or more first signals to switch on a relay of two or more relays based on the stored first state; wait for a set time after sending each first signal of the one or more first signals; and update the first state based on the order the one or more first signals were sent.

### FIELD OF ENDEAVOR

The invention relates to electrically operated switches and more particularly to relays.

### BACKGROUND

Electrically operated switches such as electrical relays are used in a variety of systems, an example of which is in electric vehicle supply equipment (EVSE). Relays control electrical energy transfer between various components of an electrical system. Repeated use of a relay by turning the relay on and off, shortens the life of the relay. Premature failure of a relay in a system leads to premature failure of the system.

### SUMMARY

Embodiments disclose a method and system for extending the useful life of electrical switches, such as relays, and the systems controlled by such switches. One embodiment comprises a system for controlling a plurality of electrical switches, each electrical switch having two or more operational states and responsive to control signals for changing between operational states. The system comprises a controller configured to generate control signals to selectively change the operational state of one or more of the electrical switches based on at least one of: a selected timing and a selected sequence. The system reduces early degradation of one or more of the electrical switches in relation to said plurality of electrical switches.

A system embodiment may include: a processor having addressable memory, the processor in communication with two or more relays, where the processor may be configured to: store a first state based on an order of two or more relays to be switched on; send one or more first signals to switch on a relay of two or more relays based on the stored first state; wait for a set time after sending each first signal of the one or more first signals; and update the first state based on the order the one or more first signals were sent.

In additional system embodiments, the processor may be further configured to: store a second state based on an order of two or more relays to be switched off; send one or more second signals to switch off a relay of two or more relays based on the stored second state; wait for a set time after sending each second signal of the one or more second signals; and update the second state based on the order the one or more second signals were sent.

In additional system embodiments, the set time may be greater than an operating time of each relay of the two or more relays. In additional system embodiments, the set time may be based on a transfer time of the two or more relays and a system power cycle time.

In additional system embodiments, the order of the two or more relays to be switched on may be in a variable sequence determined by the first state. In additional system embodiments, the two or more relays may be in an electric vehicle supply equipment (EVSE). In additional system embodiments, the processor may be further configured to: check a status of the two or more relays after the one or more first signals were sent.

In additional system embodiments, the stored first state may be configured to vary which relay of the two or more relays may be turned on as a first relay to be turned on, and where the stored first state may be configured to reduce early degradation of a relay of the two or more relays in relation to other relays of the two or more relays.

In additional system embodiments, the two or more relays comprise two relays, where a first first signal of the one or more first signals may be configured to turn on a first relay of the two or more relays based on the stored first state, where a second first signal of the one or more first signals may be configured to turn on a second relay of the two or more relays based on the stored first state. In additional system embodiments, the first first signal of the one or more first signals may be configured to turn on the second relay of the two or more relays based on the updated first state, and where the second first signal of the one or more first signals may be configured to turn on the first relay of the two or more relays based on the updated first state.

Another system embodiment may include a system for controlling a plurality of electrical switches, each electrical switch having two or more operational states and responsive to control signals for changing between operational states, the system comprising: a controller configured to generate control signals to selectively change the operational state of one or more of the electrical switches based on at least one of: a selected timing and a selected sequence; where the selective changing of the operational state of the one or more of the electrical switches may be configured to reduce early degradation of the one or more of the electrical switches in relation to said plurality of electrical switches.

In additional system embodiments, the controller may be further configured to generate control signals to selectively change the operational state of one or more of the electrical switches based on a selected timing as a function of the operational characteristics of one or more of the electrical switches. In additional system embodiments, the controller may be further configured to selectively change the operational state of one or more of the electrical switches based on a selected timing as a function of said operational characteristics including one or more of: power cycle time and switch transfer time.

In additional system embodiments, the controller may be further configured to generate control signals to selectively change the operational state of one or more of the electrical switches in a variable sequence. In additional system embodiments, the controller may be further configured to generate control signals to selectively change the operational state of one or more of the electrical switches in a variable sequence based on selected timing as a function of one or more of: power cycle time and switch transfer time.

In additional system embodiments, the controller may be configured to generate control signals to change the operational state of one or more of the electrical switches in an alternating sequence. In additional system embodiments, the controller may be further configured to change the operational state of one or more of the electrical switches in an alternating sequence based on selected timing as a function of one or more of: switch transfer time and system power cycle time.

In additional system embodiments, the controller may be further configured to change the operational state of each of the electrical switches based on a selected timing and selected sequence to prevent one or more of the electrical switches from early degradation in relation to the other electrical switches in the system.

Another system embodiment may include: a plurality of electrical switches, each electrical switch having two or more operational states and responsive to control signals for changing between operational states; a controller configured to generate control signals to selectively change the operational state of one or more of the electrical switches based on at least one of: a selected timing and a selected sequence, to reduce early degradation of one or more of the electrical switches in relation to said plurality of electrical switches.

Additional system embodiments may include: N relays; a state counter C that cycles through counts 1, 2, . . . , N, 1, 2, . . . , N, 1, 2, . . . , N, where the controller may be further configured such that in a power cycle: in a control state C, upon receiving a power on signal, a relay C may be turned on first, and then subsequent relays may be turned on in sequence after a set wait time has passed for each delay; in the control state C, upon receiving a power off signal, relay C may be turned off first, and then subsequent relays may be turned off in sequence after a set wait time has passed for each; the state counter may be incremented by one, such that when C=N, the state counter C may be reset to 1.

In additional system embodiments, the set wait time may be a function of at least one of: relay transfer time and system power cycle time.

### BRIEF DESCRIPTION OF THE DRAWINGS

The components in the figures are not necessarily to scale, emphasis instead being placed upon illustrating the principals of the invention. Like reference numerals designate corresponding parts throughout the different views. Embodiments are illustrated by way of example and not limitation in the figures of the accompanying drawings, in which:

FIG. 1 depicts an exemplary system for controlling power between a utility and an electric vehicle, which includes a controller configured to selectively change the operational state of one or more of the electrical switches such as relays, to reduce early degradation of one or more of the relays in relation to other relays in the system;

FIG. 2 depicts a cross-sectional side view of an embodiment of an EVSE and power outlet and protective enclosure;

FIG. 3 is a block diagram illustrating one embodiment of an EVSE system;

FIG. 4 is a block diagram illustrating a system including at least a controller configured to selectively change the operational state of one or more relays, such as alternating relays to extend life of relays, according to one embodiment disclosed herein;

FIG. 5 is a graphical representation of electrical and control signals in the system from FIG. 4, according to one embodiment;

FIG. 6A depicts a flow chart of a method embodiment of changing operation state of two or more relays to on, according to one embodiment;

FIG. 6B depicts a flow chart of a method embodiment of changing operation state of two or more relays to off, according to one embodiment;

FIG. 6C depicts a flow chart of a method embodiment of changing operation state of two relays to on, according to one embodiment;

FIG. 6D depicts a flow chart of a method embodiment of changing operation state of three relays to on, according to one embodiment;

FIG. 6E depicts a flow chart of a method embodiment of changing operation state of four relays to on, according to one embodiment;

FIG. 7 illustrates an example of a top-level functional block diagram of a computing device embodiment;

FIG. 8 is a high-level block diagram showing a computing system comprising a computer system useful for implementing an embodiment of the system and method disclosed herein;

FIG. 9 shows a block diagram of an example system in which an embodiment may be implemented; and

FIG. 10 depicts an illustrative cloud computing environment, according to one embodiment.

### DETAILED DESCRIPTION

The following description is made for the purpose of illustrating the general principles of the embodiments disclosed herein and is not meant to limit the concepts disclosed herein. Further, particular features described herein can be used in combination with other described features in each of the various possible combinations and permutations. Unless otherwise specifically defined herein, all terms are to be given their broadest possible interpretation including meanings implied from the description as well as meanings understood by those skilled in the art and/or as defined in dictionaries, treatises, etc.

Embodiments described herein disclose a method and system for extending the useful life of relays and the systems controlled by such relays. A relay is an electrically operated switch. An example relay comprises an electrical coil, which upon receiving an electric control signal, converts the signal to a mechanical action to move moveable electrical contacts to open and close the electric circuit. A relay may include one or more input terminals for one or more control signals to change an operational state of the relay, and further include operating contact terminals for conducting electricity from a power source therethrough. The relay may include a number of contacts in multiple operational states (e.g., contact forms), which in response to the coil change its operational state such as: making contact to close a circuit, breaking contact to open a circuit, or combinations thereof.

Each relay has operational characteristics including operation time, transfer time, and release time. The operating time of a relay comprises the elapsed time from the initial application of power to the coil, until the closure of the normally open contacts. As such, the operating time of a relay comprises the time for the magnetic field to form (so the switch contact is attracted), plus the transfer time of the moveable contact (from its open to its closed position). The release time of a relay comprises the elapsed time from the initial removal of coil power until the reclosure of the normally closed contacts (this time does not include bounce). As such, the release time of a relay comprises the time for the magnetic field to weaken and cease (so the switch is no longer attracted), plus the transfer time of the moveable contact (from its closed to its open position). The electrical system, including the relays, has an associated power cycle time period which is the time between one power on, to the next, or from one power off to the next.

An example use of relays is in an electrical system utilizing two or more relays for delivering electrical power to an electrical load. In one example, an electrical load comprises an electrical device or component that consumes electrical energy and converts that energy into another form (e.g., resistive loads, inductive loads, capacitive loads, etc.).

In system operation, typically control signals to turn two or more relays on/off are sent to the relays at the same time. In actual use, even similar relays do not operate at the same speed in response to the control signal to open or close the relay contacts. Although all the relay coils are energized and de-energized at the same time, no two relays have exactly the same response time. There will always be a slight difference in the closing and opening times of the relays. If one relay consistently closes last, it will experience more arcing than a relay that closes first. Arcing is the primary cause of relay electrical contact wear and degradation and even a slight increase in contact resistance can significantly increase the heat generated due to power loss at the contact, negatively affecting the system. This is because in practice the order of opening and closing relays in a system is in a fixed or static sequence (i.e., one relay always being faster or slower to turn on/off).

For example, in a system utilizing two or more relays in an electrical circuit to deliver electrical power from a power source to a load, control signals (i.e., actuation signals) to turn the relays on are sent to the relays at the same time to close the circuit between the power source and the load, allowing the flow of electrical current between the power source and the load. However, one of the relays may be slower to turn on (and/or turn off) than other relays. Whichever relay turns on slower, generally consistently turns on slower, which results in extra electromechanical forces and electrical arcing being applied to that relay, reducing the life cycle of that relay and the system as a whole.

Both when a relay turns on and turns off, there is some level of stress and damage applied to the relay. In a system having two or more relays, when a controller sends a signal to turn relays on and/or off at the very same time, one of the relays will consistently turn on and/or turn off faster than the other relay or relays. A relay that turns off faster generally consistently turns off faster. The first relay to turn off or release (e.g., break contact) is the relay that is exposed to the brunt of electromechanical force on the release cycle. Such repeated exposure of a relay among several relays causes early failure of that relay.

The disclosed embodiments herein provide a controller and method for selected timing of control signals to multiple relays in a system, such that certain relays (e.g., slower, or faster relays) would not absorb a larger portion of electromechanical energy from turning on or off, compared to other relays. In another embodiment, a controller and method disclosed herein provide selected timing of control signals to multiple relays to substantially equally distribute electromechanical energy from turning on or off among relays in a system. In another embodiment, a controller and method disclosed herein provide selected timing of control signals to multiple relays such that relays are turned on/off in a changing sequence. In another embodiment, a controller and method disclosed herein provide selected timing of control signals to multiple relays such that the order (i.e., sequence) of opening and closing relays is not in a static sequence. In another embodiment, a controller and method disclosed herein provide selected timing of control signals to multiple relays such that the order of opening and closing relays is in an adjustable sequence. In another embodiment, a controller and method disclosed herein provide selected timing of control signals to multiple relays such that the order of opening and closing relays is in a variable sequence. In another embodiment, a controller and method disclosed herein provide selected timing of control signals to multiple relays such that the order of opening and closing relays is in an adaptable sequence. In another embodiment, a controller and method disclosed herein provide selected timing of control signals to multiple relays such that the order of opening and closing relays is in a dynamic sequence.

In another embodiment, a controller and method disclosed herein provide selected timing of control signals to multiple relays such that the order (sequence) of changing the operational state of the relays is a function of the operational characteristics of one or more of the relays.

In another embodiment, a controller and method disclosed herein provide changing the operational state of the relays as a function of the operational characteristics of one or more of the relays. In another embodiment, a controller and method disclosed herein provide a selected timing for changing the operational state of the relays, wherein the selected timing is a function of the operational characteristics of one or more of the relays in the system. In another embodiment, a controller and method disclosed herein provide a selected timing of changing the operational state of the relays, wherein the selected timing is a function of at least one of: the operational characteristics of one or more of the relays, and the power cycle time in the system.

In another embodiment, a controller and method disclosed herein provide selected timing of control signals to multiple relays such that the order of opening and closing relays in a sequence as a function of switch transfer time and system power cycle time.

According to one embodiment disclosed herein, said selected timing comprises a set time to wait between in a sequence of turning relays on or off. In one example, the set time to wait is based on the ‘time to actuate’ or transfer time of a relay, and the system power cycle time.

The disclosed embodiments provide a controller and method for selected timing of control signals to multiple relays in a system such that each relay can take turns absorbing electromechanical energy including destructive arcing (electrical spark) energy released when a relay is closed or released first. In a system including N relays (where Nis an integer greater than 1), a relay that would normally absorb more of electromechanical energy from turning on or off first, will only absorb such energy about 1/N number of times according to an embodiment disclosed herein. For example, in a system including two relays (N=2), a relay that would normally absorb more electromechanical energy from turning on or off first, will only absorb such energy about half the number of times.

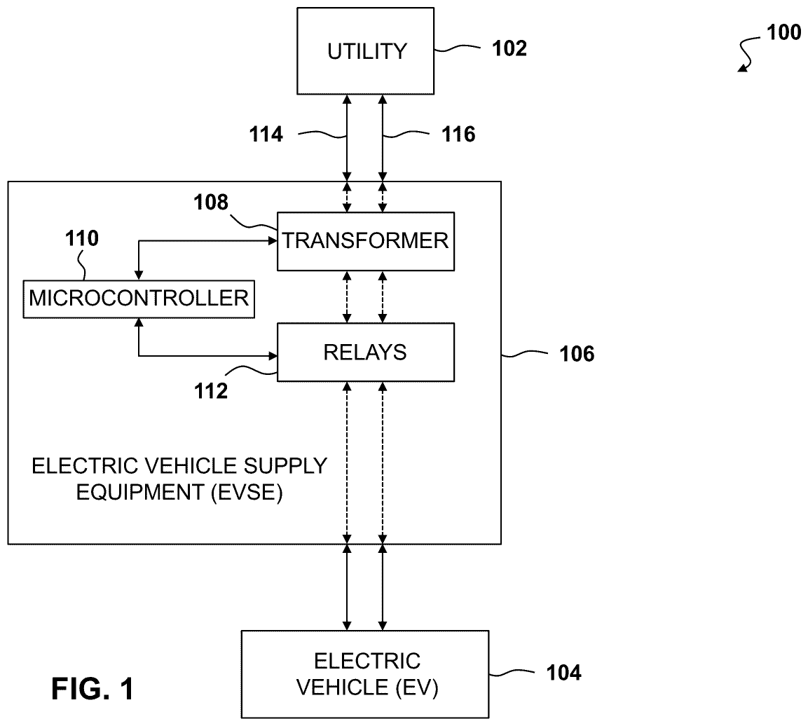

Examples embodiments are disclosed herein in conjunction with electric vehicle supply equipment (EVSE) for an example context, however the disclosed method and system herein can be implemented in different electrical systems. In an EVSE including multiple relays, if one of two or more relays is switched on or switched off more frequently than another relay, such a relay may fail prematurely or go into a reduced/degraded state of operation degrading system performance. FIG. 1 depicts an exemplary system 100 for controlling power between a utility 102 and an electric vehicle (EV) 104. The system may include an EVSE 106 to charge the EV 104 with power provided by the utility 102. While this system is described with reference to an EVSE, it may be applied to other electrical systems, such as a wall socket in a building. The EVSE 106 may include a current sensing transformer 108. One or more utility lines 114, 116, depicted as solid lines and dashed lines in the EVSE 106, may connect to the transformer 108.

A microcontroller 110 may be in communication with the transformer. The microcontroller 110 may determine if a fault event occurs. In some embodiments, the fault event may be a leakage current fault, temperature fault, or other faults. The vehicle or user may also command the EVSE to end the charge session for any reason. The microcontroller 110 may send a signal to two or more relays 112 and/or to the transformer 108 to control power between the EVSE 106 and/or the EV 104 and the utility 102. While a microcontroller 110 is depicted in the system 100, one or all of its functions may be replaced by analog and logic circuitry in some embodiments as disclosed herein. Likewise, additional microcontrollers may be used to accomplish different functions.

The microcontroller 110 may further be configured to selectively change the operational state of one or more of the relays 112 on/off, to reduce early degradation of one or more of the relays in relation to other relays in the system, according to the embodiments disclosed herein.

The two or more relays 112 may each include one or more contacts, such as a first contact and a second contact. In some embodiment, there may be more than two contacts. In some embodiments, the system and method disclosed herein may be applied to multiple relays.

The microcontroller 110 may send a relay signal to the two or more relays 112 to each switch on and/or switch off. While a microcontroller 110 is depicted in the system 100, one or all of its functions may be replaced by analog and logic circuitry in some embodiments as disclosed herein. In some embodiments, the microcontroller 110 may continuously check the status of the two or more relays 112 to detect system or relay conditions. In some embodiments, the microcontroller 110 checks the status of the two or more relays 112 at a set interval to detect any fault or degradation conditions. In some embodiments, the microcontroller 110 may only check the status of the two or more relays 112 when the relay is expected to change state, such as when a new relay signal is sent to the relay to switch from on to off. In some embodiments, the microcontroller 110 may check the two or more relays 112 continuously.

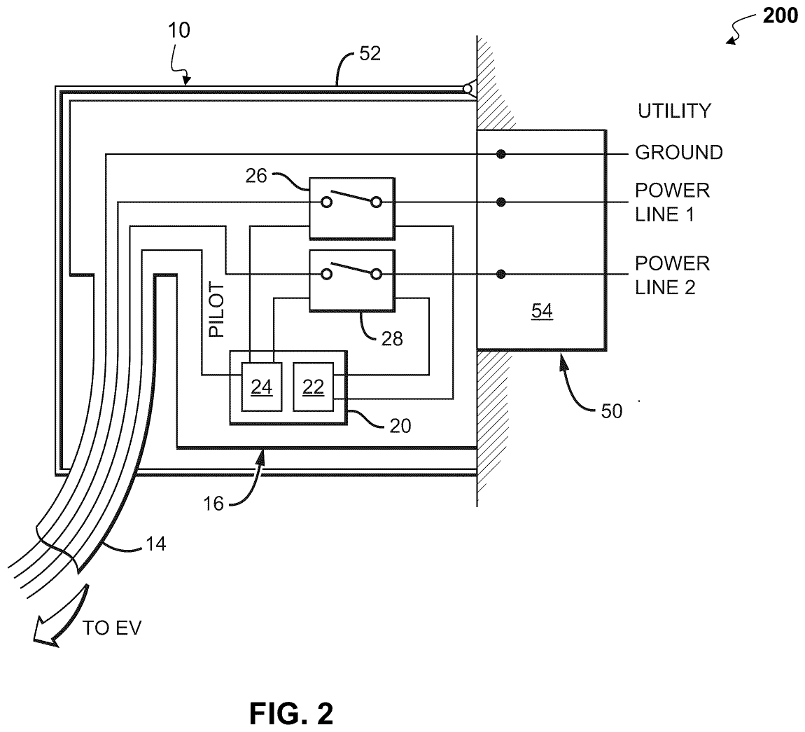

FIG. 2 depicts a cross-sectional side view and schematic of an embodiment of a system 200 including an EVSE 10, power outlet, and protective enclosure, in which embodiments of the system and method disclosed herein may be implemented. In embodiments, the EVSE 10 includes a cord 14 and a case 16 and is shown plugged into a power outlet 54 of a power source 50 and within a protective cover 52. The EVSE 10 shown includes a control system 20 that is connected to a pilot line, which in turn may be connected to an electric vehicle via a connector (not shown). The control system 20 is further connected to a set of contactors, relays, or electrical switches 26 and 28, which function to control the flow of power from the power source 50 to the vehicle. In one embodiment, the control system 20 is configured to selectively change the operational state of one or more of the electrical switches such as relays, to reduce early degradation of one or more of the relays in relation to other relays.

In one embodiment, the control system 20 operates to open or close the relays 26 and/or 28 as directed by the status of the pilot signal on the pilot line, including as directed by the vehicle or when the pilot line is disconnected from the vehicle. The control system 20 can include a relay controller 22 and a relay monitor 24. The relay controller 22 controls the operation of the relays 26 and/or 28 to selectively change the operational state of one or more of the relays, to reduce early degradation of one or more of the relays in relation to other relays, according to embodiments disclosed herein. In one embodiment, the relay monitor 24 checks that the operation or position of relays 26 and/or 28 matches their commanded position or positions. In the event the relay monitor 24 detects that either relay 26 and/or 28 are not functioning as commanded, the relay monitor 24 will indicate an error has occurred in the operation of the EVSE 10. Such indication may be by illuminating a warning light (not shown).

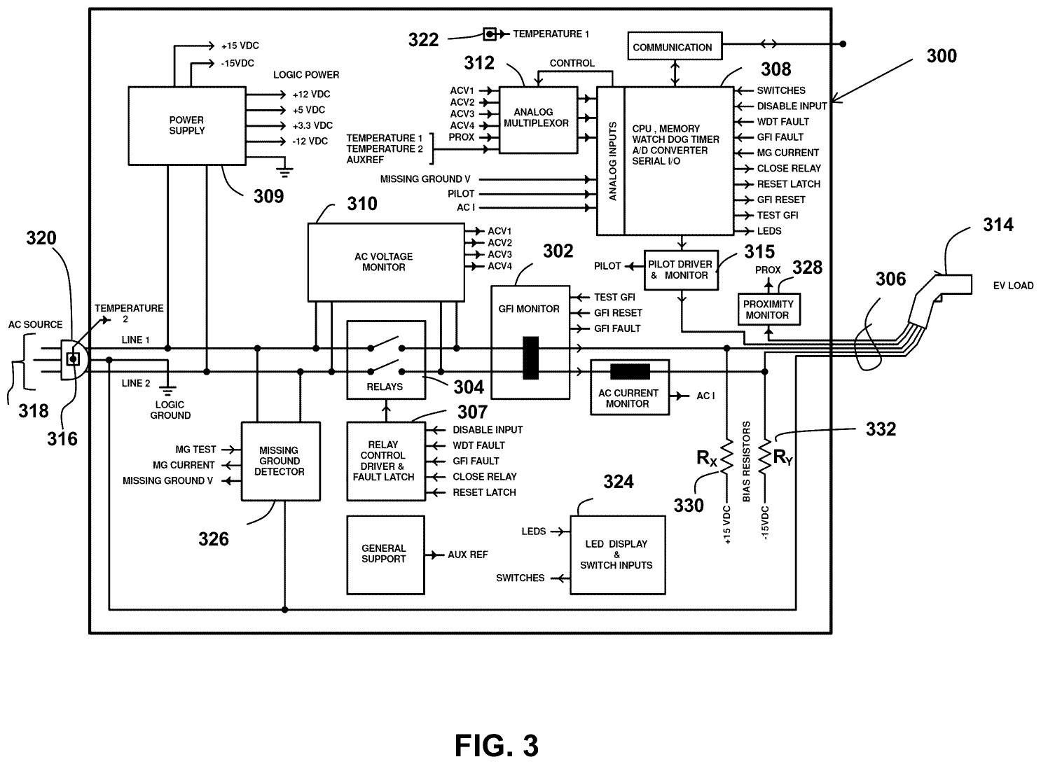

FIG. 3 illustrates one embodiment of an EVSE system 300 that uses AC utility power to charge electric vehicles. The system is operable to plug into an AC source that may be 120 VAC-60 Hz, 250 VAC-60 Hz (split phase) or 230 VAC 50 Hz (80 VAC to 264 VAC) via a standard NEMA or CEE7/7 plug from a standard household utility socket. The AC power is routed to a GFI Monitor 302 that is a GFI/RCD (Ground Fault Interrupter/Residual Current Device current sensor) through relays 304 for presentation to an EV charge cable 306. The relays 304 are normally open (N. O.) when de-energized, so logic power must be present in order to initiate and maintain the relay-closed condition. The relay or relays 304 open/close operation is driven by the relay control driver 307. In one embodiment, the relay control driver 307 may be configured to selectively change the operational state of one or more of the relays 304 on/off, to reduce early degradation of one or more of the relays in relation to other relays in the system, according to the embodiments disclosed herein.

In one embodiment, the GFI monitor 302, relay control driver and fault latch controller 307 collectively provide a robust hardware safety system. A controller 308 receives line voltage signals from an AC voltage monitor 310 through an analog multiplexor 312, with the AC voltage monitor 310 monitoring the voltage on Line 1 and Line 2 and across the relays 304 for communication to the controller 308. The controller 308 includes a microprocessor and control monitoring electronics, with logic power being supplied by a power supply 309 that may be a flyback transformer-based power supply to allow for use of the EVSE system 300 in different power environments. The prime function of the controller 308 is to use the inputs from the vehicle connector and utility to allow or disallow the relays to open and close. It allows closure when conditions are normal and ensures the relays open in any safety-required fault or disconnection event. It obtains its operating power from the utility at the input of the EVSE system 300.

A charge coupler 314 such as an SAE-J1772 or IEC-62196 Type II, Mode 2 compliant connector is in communication with the EV charge cable 306 to feed the AC power to an EV (not shown) that may be coupled to the charge coupler. The EV (now shown) may contain an onboard charger that then converts the AC power to DC power to charge the vehicle batteries. For example, in preparation to operate the EVSE system 300, the connector is attached by the user to the vehicle receptacle for charging sessions. The vehicle is the primary system component per SAE-J1772/IEC62196 that communicates charging status and completion to the user, however the controller 308 may be designed to provide a primary pilot signal through the pilot driver and monitor 315, with the pilot signal established between the EVSE and the vehicle per SAE-J1772 prior to closing the relays 304. The pilot signal is passed through the charging cable 306 to the vehicle and may have a peak amplitude of +/−3 V and a PWM (Pulse Width Modulation). Per SAE-J1772, the duty cycle of the pilot PWM signal is used by the EVSE system 300 to communicate the maximum power amperage limit that the EVSE system 300 may supply to the vehicle. The pilot signal voltage amplitude and modulation characteristics are used to indicate a proper connection, charging requirements, and default status between the vehicle and the EVSE system 300.

Also included in the EVSE system 300 may be a plug blade temperature thermistor 316 positioned and potted in thermal communication with the plug blades 318 of a receptacle plug blade assembly 320, with the plug blade temperature thermistor 316 in communication with the controller 308. A reference temperature thermistor 322 is positioned remotely from the plug blade temperature thermistor 316 to enable measurement of differential temperatures at such locations and is also in communication with the controller 308. With the inclusion of the plug blade temperature thermistor 316 and reference temperature thermistor 322, means are provided for avoiding excessive heat that may cause damage to the receptacle plug blade assembly by using either an absolute temperature as measured at the receptacle plug blade assembly or a temperature differential calculated using measurements taken by the plug blade temperature thermistor and reference temperature thermistor to enable intelligent control of the EV charging current through modulation of the pilot signal sent by the controller 308.

The EVSE system 300 may have a user interface 324 that may include an LED light or lights and one or more switch inputs that are in communication with the controller 308. In one embodiment, the LED light is one green LED. When the EVSE system 300 is not plugged into a wall outlet, the LED may be off. When the EVSE system 300 is plugged into a wall outlet and is not charging (stand-by state) the LED may be solid on. During the charging state, the LED will display a smooth transition from fully on to barely visible. The trouble codes may be depicted through various flash rates of the LED that will be distinctly different from the other states. Because the EVSE system 300 is able to communicate through the charge coupler 314, in one embodiment, the charge coupler 314 may be connected to a personal computer to configure the EVSE system 300 for a maximum current rating for a particular region. Software embedded or otherwise stored and used by the controller 308 may be updated through the charge coupler 314 to make upgrades in the field very easy. Also included in the EVSE system 300 is a missing ground detector 326 in electrical communication with both line 1 and line 2 to provide missing ground current and missing ground voltage signals to the controller 308. As shown more particularly, a proximity monitor 328 is in electrical communication with the charge coupler 314 through the EV charge cable 306 to enable EVSE programming. A DC bias circuit is provided through bias resisters Rx 330 and RY 332 (preferably 300 k ohms, each) in electrical communication with Line 1 and Line 2, respectively, to enable bipolar output impedance and welded contact tests.

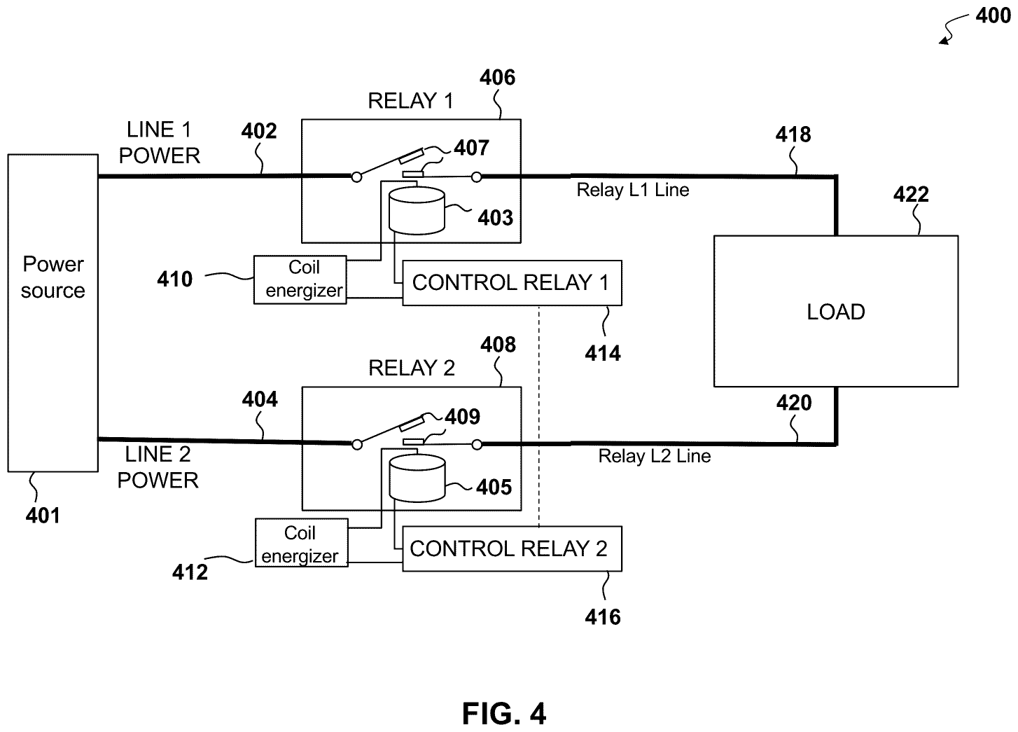

In one embodiment, a controller and method disclosed herein provide selected timing of control signals to multiple relays such that relays are turned on/off in an alternating sequence. FIG. 4 is a block diagram illustrating an electrical system 400 for alternating relays to extend relay life, according to one embodiment. The system 400 may include a first powerline 402 (Line 1 Power) connecting a first relay 406 (RELAY 1) to an electrical power source 401, and a second powerline 404 (Line 2 Power) connecting a second relay 408 to the power source 401. The first relay 406 may include a first coil 403 connected to a first relay control 414 (Control Relay 1) and a first coil energizer power source 410 (e.g., 15V power source).

Activating the first coil by the first relay control 414 may close the contacts 407 of the first relay 406 and provide power to a load 422 via an electrical power line 418 (Relay L1 Line) when both the relays 406 and 408 are turned on. The second relay 408 may include a second coil 405 connected to a second relay control 416 (Control Relay 2) and a second coil energizer power source 412 (e.g., 15V power source). Activating the second coil 405 by the second relay control 416 may close the contacts 409 of the second relay 408 and provide power to the load 422 via an electrical power line 420 (Relay L2 Line) when both the relays 406 and 408 are turned on. The load 422 is powered by the power source 401 when both the relays 406 and 408 are turned on (i.e., powered on, closed, make contact).

In one embodiment, the relay controller 414 and the relay controller 416 are configured to provide selected timing of control signals to energize (and de-energize) the relay coils 403, 405, such that relays 406 and 408 are turned on/off in an alternating sequence, such that same relay is not always first to turn on or first to turn off. In one embodiment, the controllers 414 and 416 are in communication for synchronizing sending control signals to the relays. In another embodiment the controllers 414 and 416 may be implemented in one microcontroller 110 (FIG. 1) for controlling multiple relays.

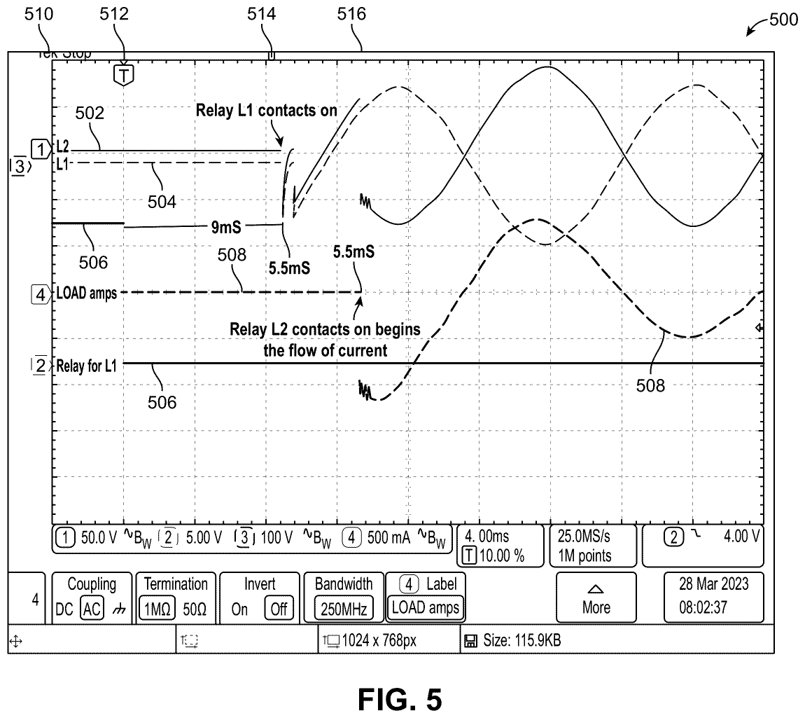

FIG. 5 shows a cartesian representation 500 of electrical signals in an example operation of the system 400 of FIG. 4, according to one embodiment disclosed herein. In the representation 500, the horizontal axis represents time, and the vertical axis represents signal amplitude. The graph 506 indicates the control signal to the first relay 406 (RELAY 1) from the controller 414. At a first time 510, the controllers 414 and 416 signal the coil energizers 410, 412, respectively, to maintain the coils 403 and 405 de-energized, whereby both relays 406, 408 are turned off.

At a second time 512, the control signal 506 from the first relay controller 414 to the coil energizer 410 goes low to turn on the first relay 406, whereby the coil energizer 410 begins to energize the first coil 403 and after a transfer time a magnetic field build up causes the contacts 407 to make contact/close (relay 406 is turned on) at a third time 514. In one example, it takes a transfer time of about 9 ms from the second time 512 when the controller 414 signals the coil energizer 410 to turn on the coil 403, for the contacts 407 to close and the relay L1 contact line 418 to be energized.

Between the second time 512 and a third time 514, the second relay controller 416 is turned on whereby a control signal (not shown) to the coil energizer 412 causes the coil energizer 412 to begin energizing the second coil 405 and after a transfer time a magnetic field build up in the second coil 405 causes the contacts 409 of the second relay 408 to make contact/close (relay 408 is turned on) at the fourth time 516. At this time (e.g., about 5.5 ms after the third time 514), with both the first and second relays 406 and 408 turned on (i.e., contacts closed), current signal 508 flows between the power source and the load 422 through the relays 406 and 408. Current signal 508 does not begin to flow until both relays 406 and 408 are on (i.e., closed, engaged). In this example, at the fourth time 516, the electrical signal 504 on the Relay L1 Line contact 418 is 180 degrees out of phase with the electrical signal 502 on the Relay L2 Line contact 420, to provide 240V split phase power.

In the example operation shown in FIG. 5 for the system 400 in FIG. 4, the first relay 406 is turned on first and then the second relay 408 is turned on, wherein the second relay 408 is exposed to more electromechanical stress as compared to the first relay 406. The same process as shown in FIG. 5 for turning each of the relays on, occurs in reverse order when each of the relays are turned off.

Graphs 502 and 504 show signal bounce at relay contacts. The signal 504 for Relay L1 Line and the signal 502 for Relay L2 Line are in phase, which means that only one of the relay contacts has transferred (i.e., closed).

At the third time 514, about 9 ms after the second time 512, the first relay contacts engage and the Relay L1 contact line is energized. Current 508 does not yet begin to flow at the third time 514. When only the first relay 406 is on, the voltage at the other side of the load 422 follows at the same potential, and current does not flow from the power source 401 through the load 422.

The electrical system including the relays, has an associated power cycle time period which is the time between one power on, to the next, or from one power off to the next. In one example, power cycle time means 50 Hz or 60 Hz utility power supply grids. It can mean other periods of time for one complete cycle of system operation. At 60 Hz, the time period for one power cycle is about 16.7 milliseconds (ms) or about 0.0167 seconds from start to finish. For 50 Hz, the power cycle time period is about 20 ms which for 120 Volts AC means at time 0 ms at the start of a power cycle. voltage signal is 0V (i.e., zero crossing positive slope). At 5 ms, the voltage signal has risen to about 180 V (i.e., positive or maximum peak). At 10 ms, the voltage signal has returned back to 0V (i.e., zero crossing negative slope). At 15 ms, the voltage signal is down at −180V (i.e., negative minimum peak), and then at 20 ms, the voltage signal returns back to zero which is the start of a new power cycle.

According to one embodiment disclosed herein, said selected timing comprises a set time to wait in a sequence of turning relays on or off using actuation and de-actuation control signals, respectively. In one example, the set time to wait is based on the ‘time to actuate’ or transfer time of a relay, and the system power cycle time. In one example embodiment, in relation to the system power cycle time, if (a) the relay transfer time is 25 ms from the actuation signal to turn on the relay and the time relay contacts are closed and the relay is on, and (b) it is desired to turn on the relay during the positive slope of the voltage signal zero crossing, then once that zero crossing signal is detected (e.g., for a 50 Hz system) a timer is set to wait for 15 ms before actuating the next relay. Five milliseconds later a voltage signal zero crossing occurs and after the remaining transfer time of 20 ms is elapsed, the relay contacts would complete that connection, doing so at that next zero crossing.

Another example is with a relay that has a transfer time of only 5 ms. A common signal to sense is when the incoming power electrical signal crosses the zero-voltage point. For a 50 Hz system, once the zero crossing is detected, it will be another 20 ms before the next zero crossing. At that time, sending an actuation signal to turn on the relay (i.e., close relay contacts), the relay would be actuated 15 ms after detection of a zero crossing. Then 5 ms later the contacts will have transferred and zero crossing is achieved.

With temperature variation and the effects of aging, it is possible for a relay transfer time to change. According to one embodiment disclosed herein, when using two or more relays in a system, one relay is completely closed (transfer time including any bouncing of the contacts) before the other relay starts closing. This is based on pertinent relay specifications and adding a time period safety factor in determining said set time to wait.

In one example application, for reasons of safety when using alternating current (AC) utility power in an EVSE to charge an electric vehicle, it is required to switch on both lines 402 and 404 via the relays 406 and 408, respectively. The relays used for electric vehicle charging are rated for such an application and at full power transfer may last about 10,000 on/off cycles. Separate relays are needed for safety reasons to apply power from a source utility having 120V, 240V, or other voltage supply. When turning two or more relays on, the priority is to turn both relays on at the same time. When a system sends a signal to turn both relays on and/or off at the very same time, one of the relays will consistently turn on and/or turn off faster than the other relay or relays. A relay that turns off faster generally consistently turns off faster. The first relay to turn off or release is the relay that gets the brunt of the force on the release cycle.

The disclosed system and method herein intentionally alternates between turning on relays so that each relay can take turns absorbing the destructive arc energy released when the relay is closed or released first. The relay that would normally absorb more of this destructive energy from turning on or off first will only absorb this energy about half the time in the disclosed system and method.

The load that the relay contacts are powering is different than what the life testing load is. Consequently, a relay rated for 10,000 cycles will translate into 5,000 through 8,000 cycles for a typical system using two relays where one of the relays consistently turns on and/or off before the other relay. The faster relay may not have a longer cycle life. Therefore, a system could last as few as 5,000 cycles or 8,000 cycles even though the individual relays are rated for 10,000 cycles each. By contrast, a system with two relays and controllers implementing embodiments of the system and method disclosed herein may be able to be extended to 10,000 or even 12,000 relay on/off cycles by alternating the destructive energy absorbed by any one relay in the system.

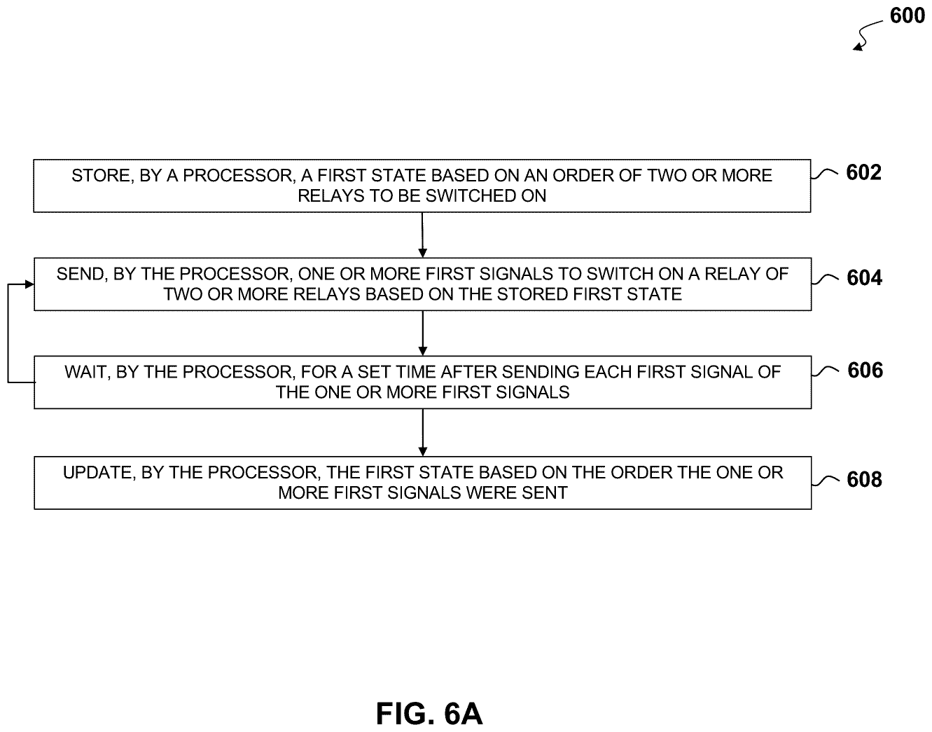

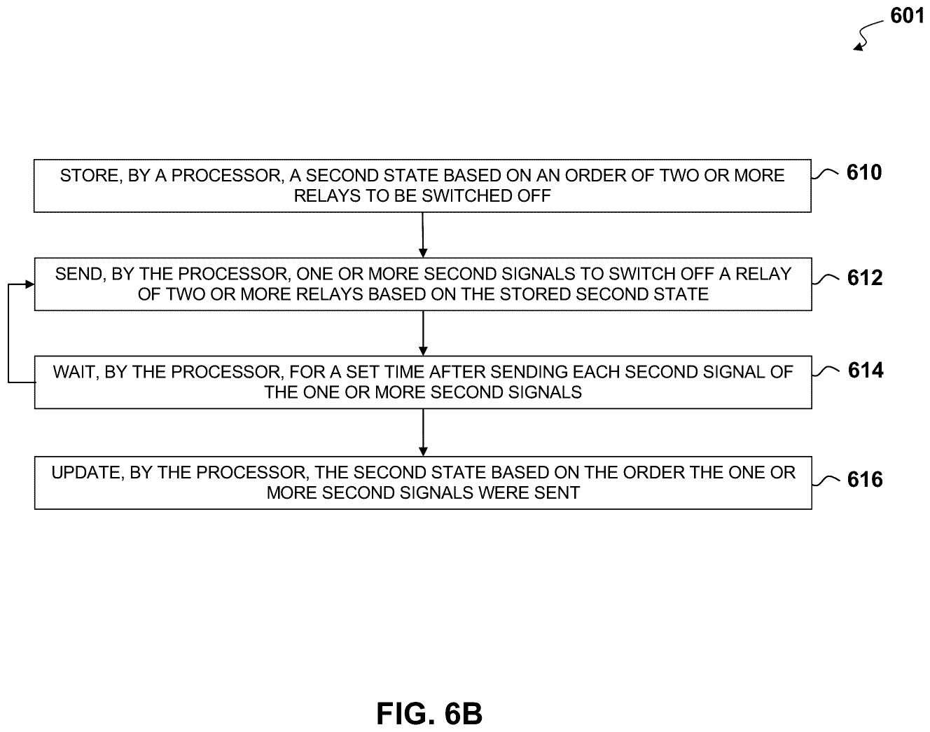

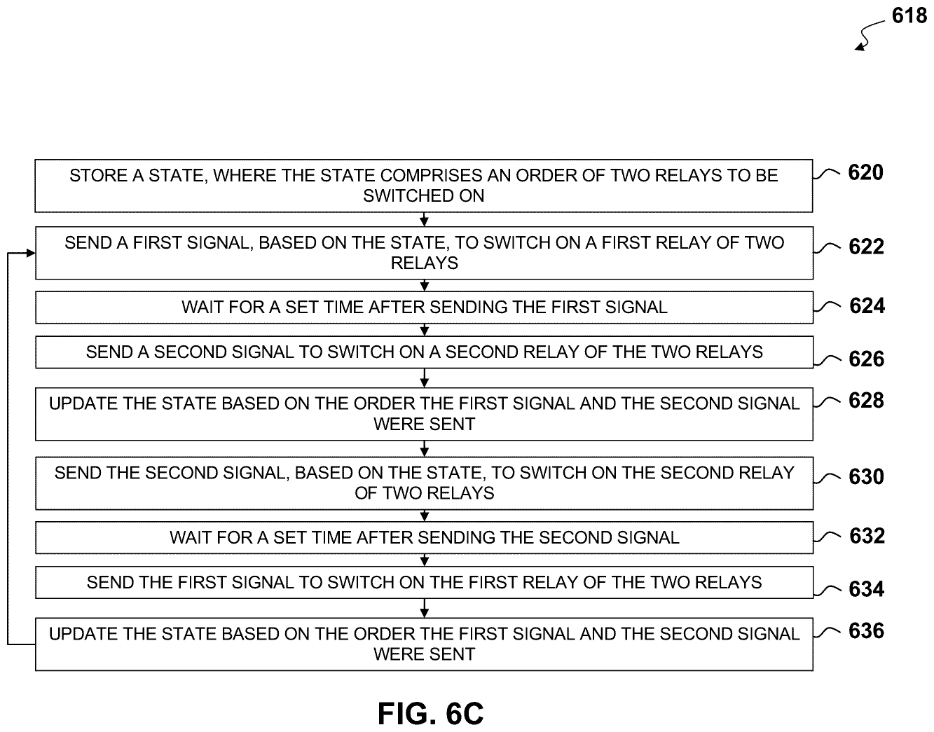

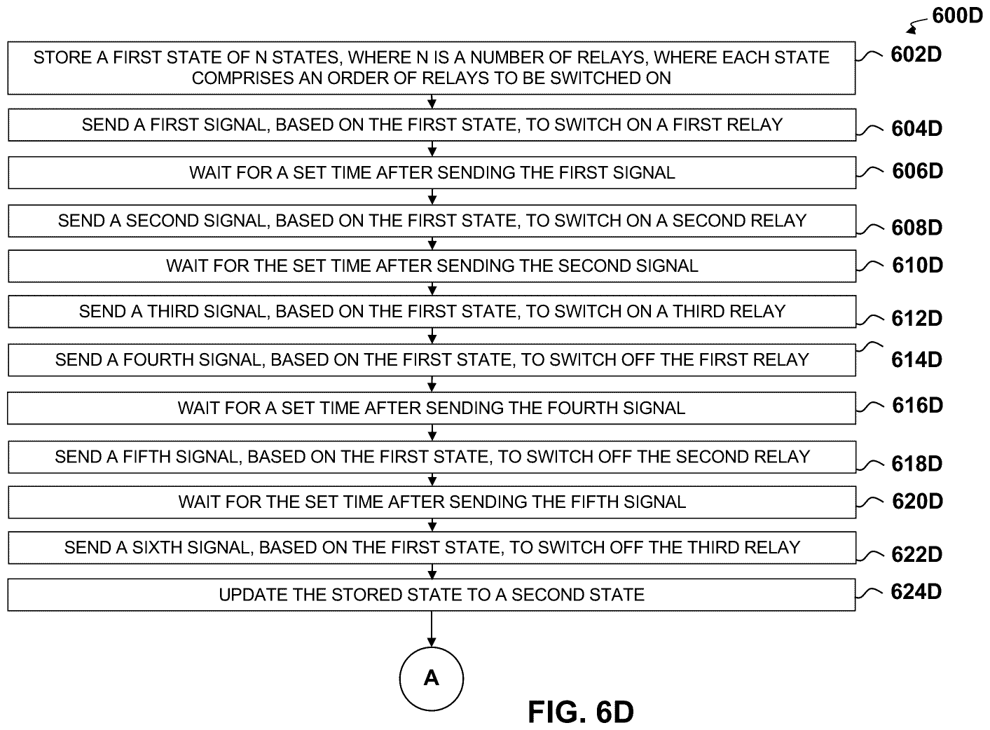

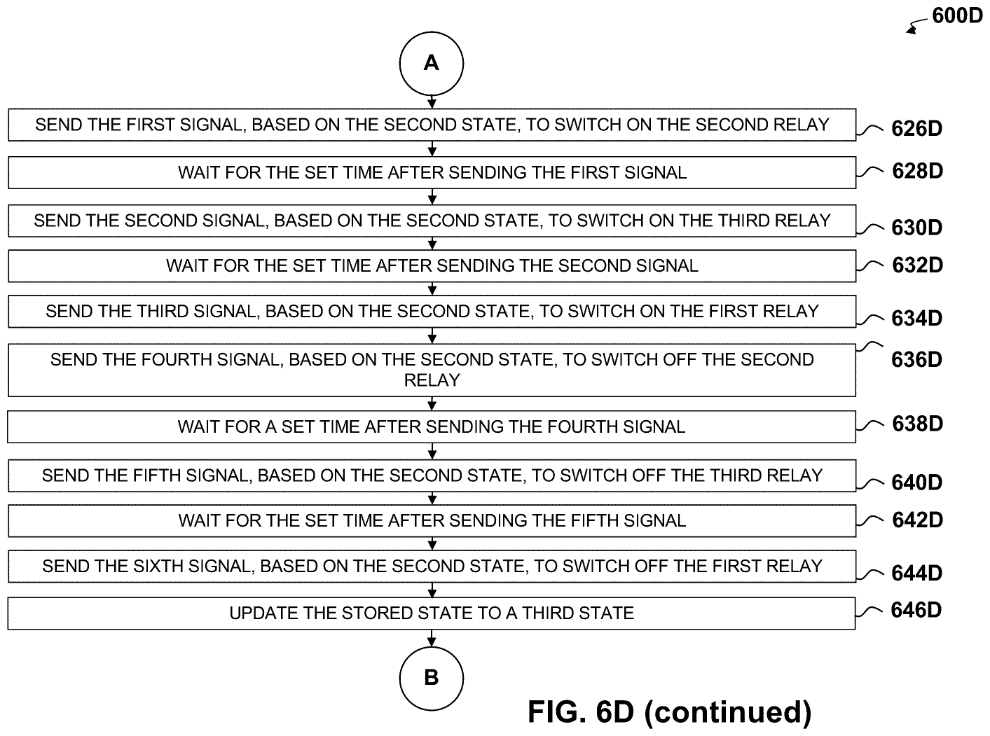

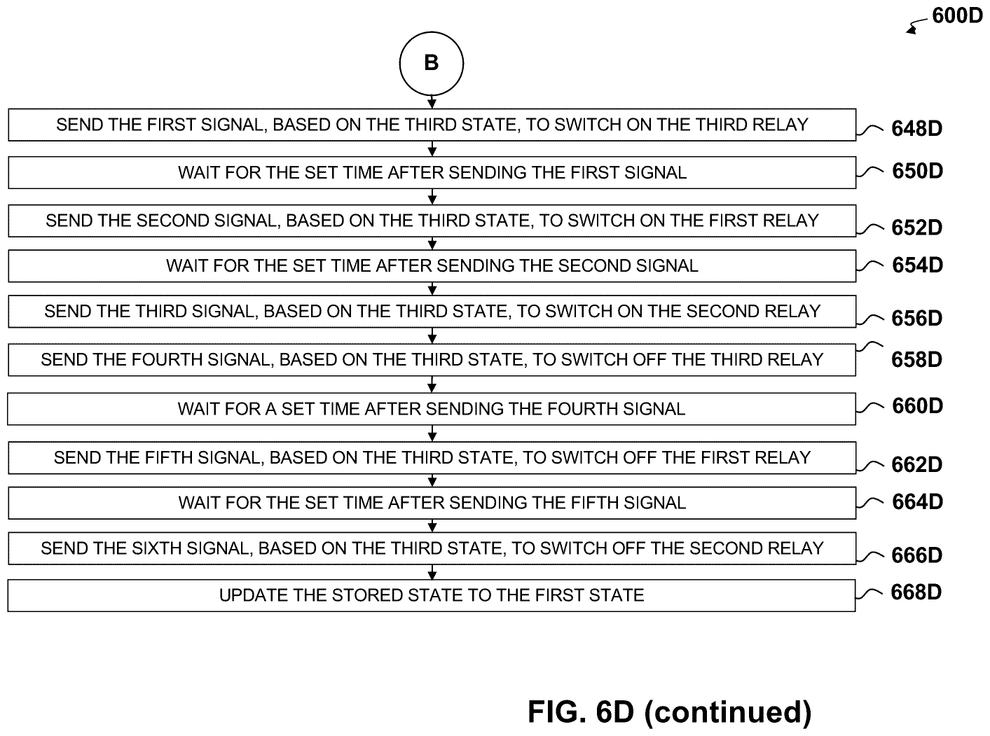

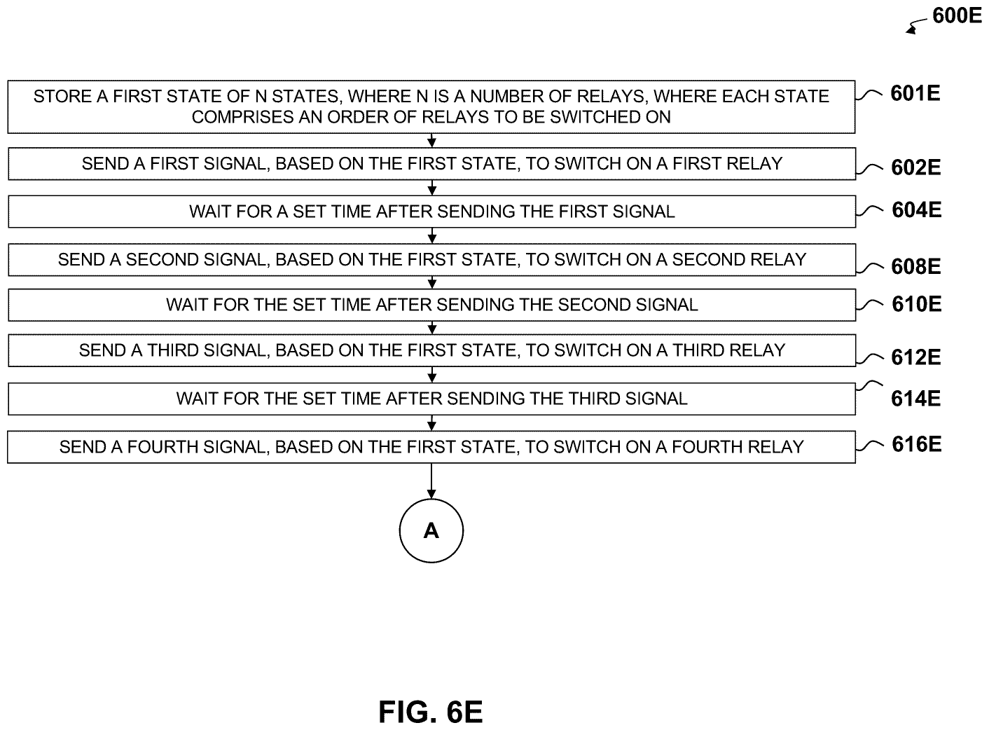

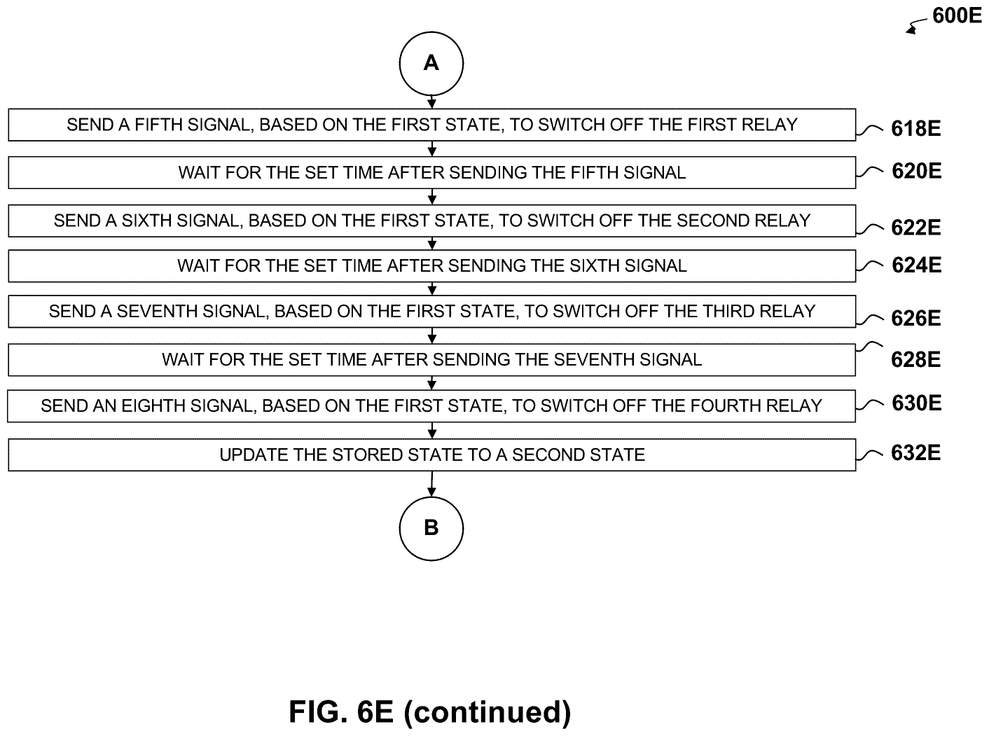

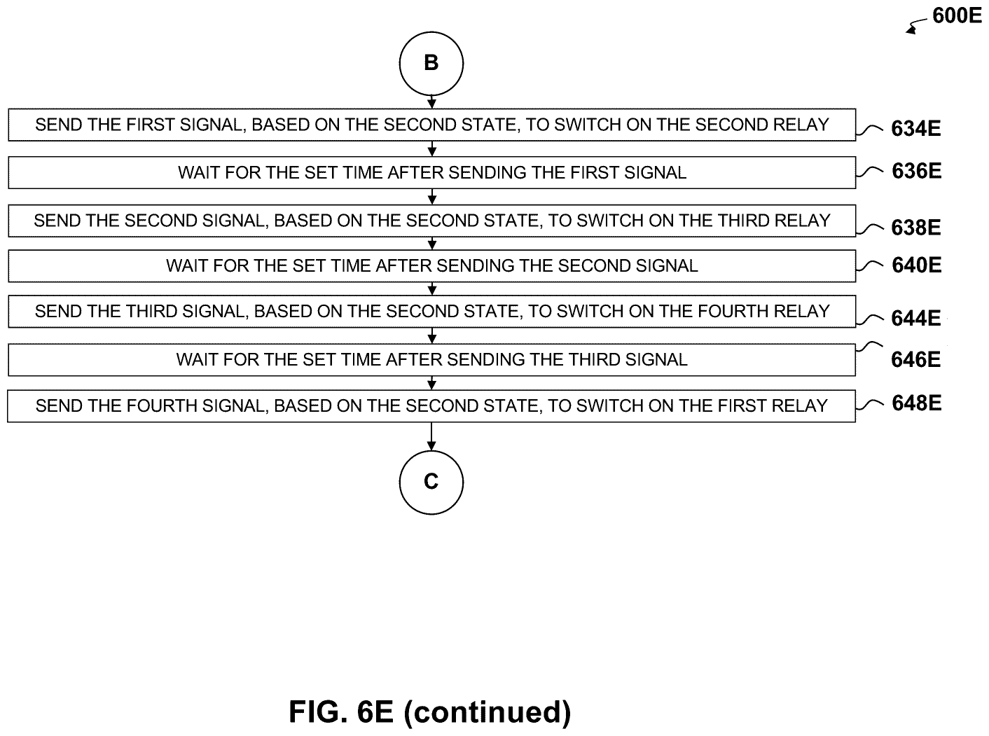

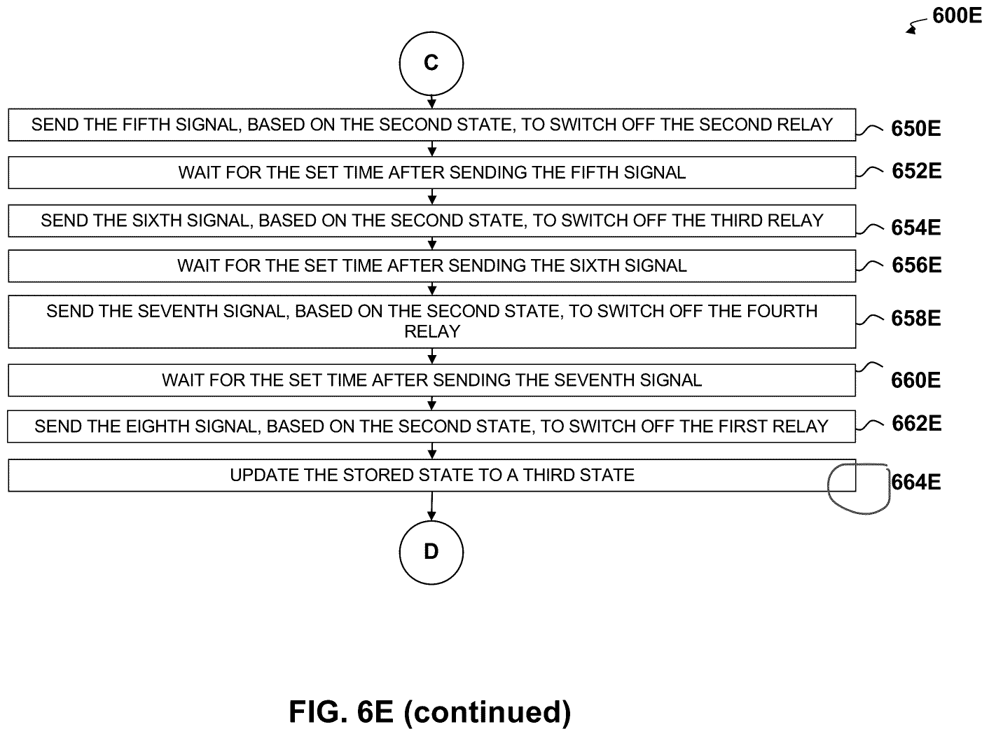

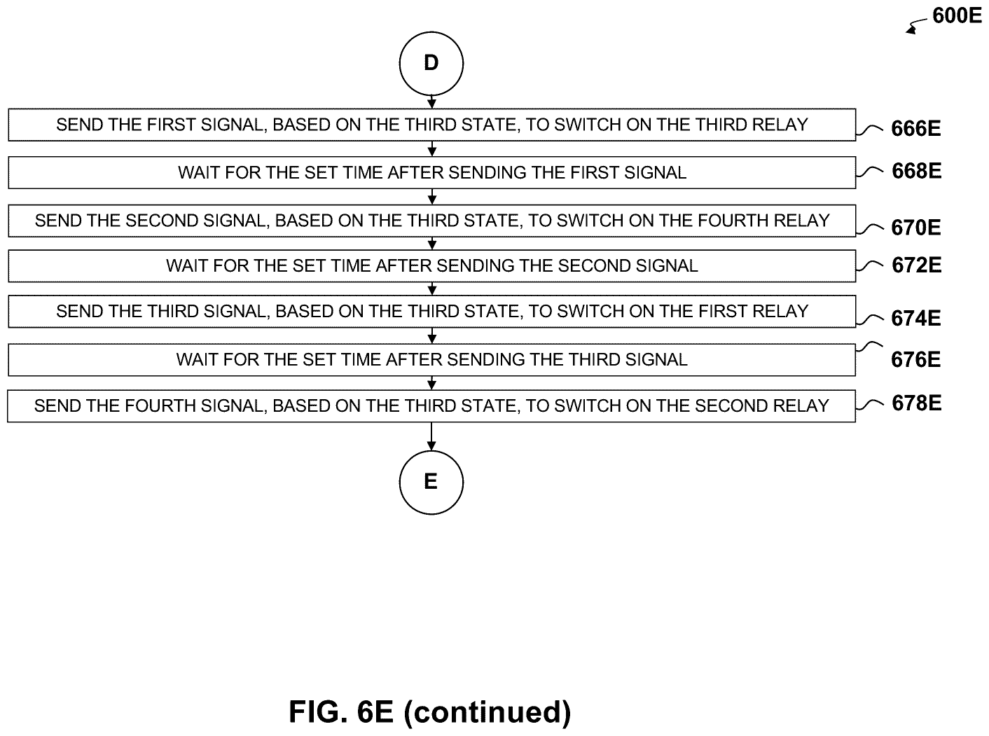

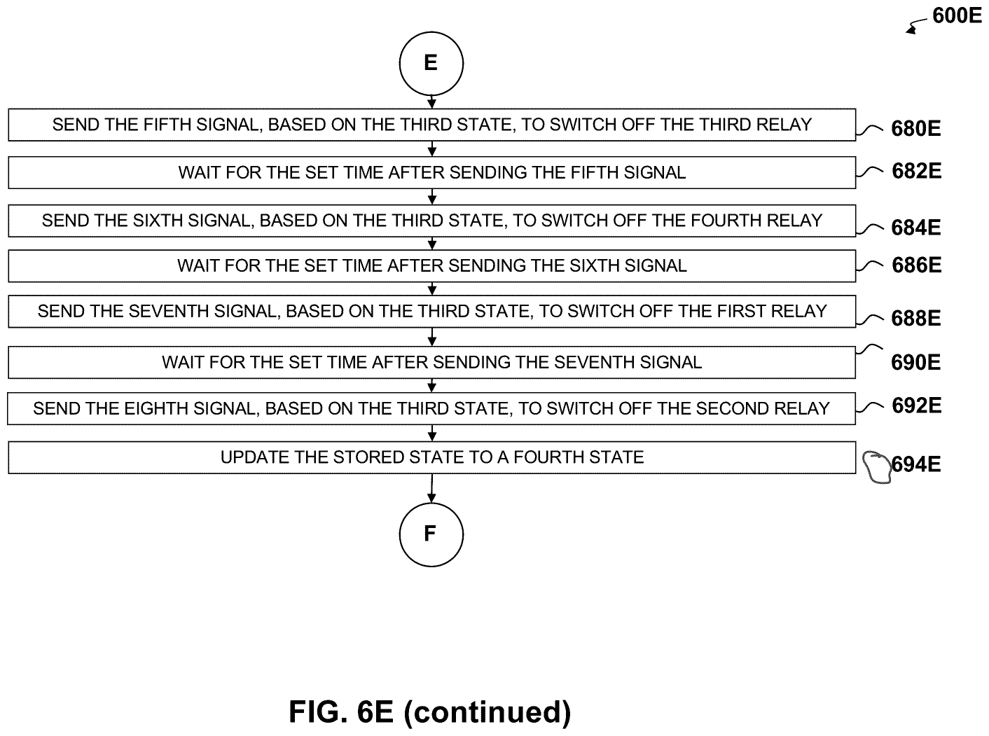

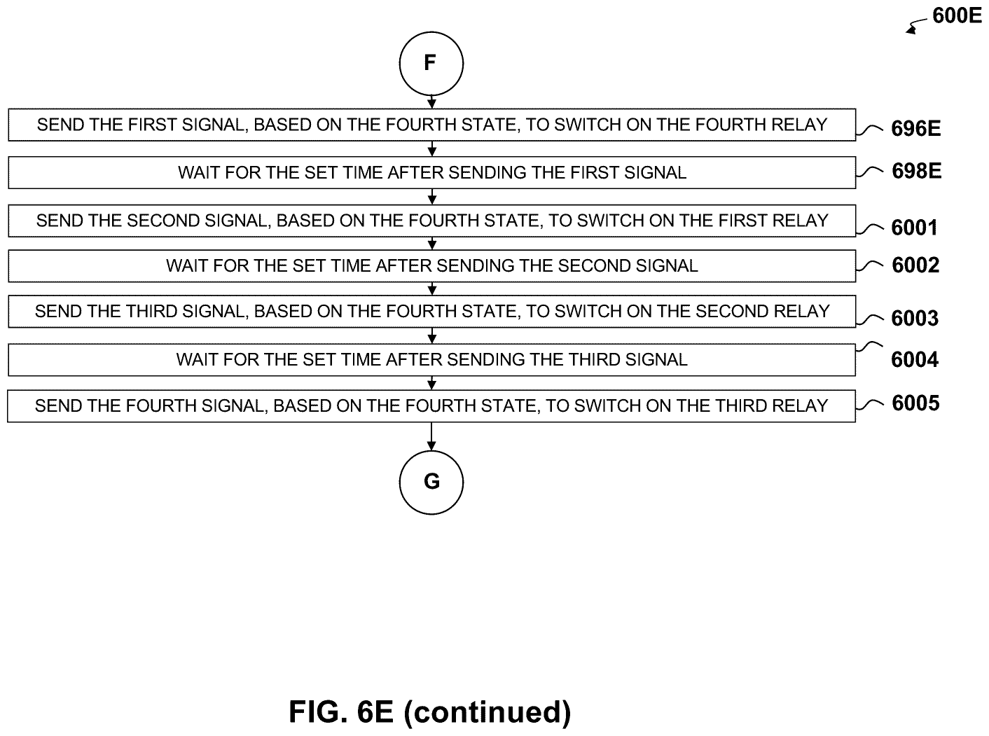

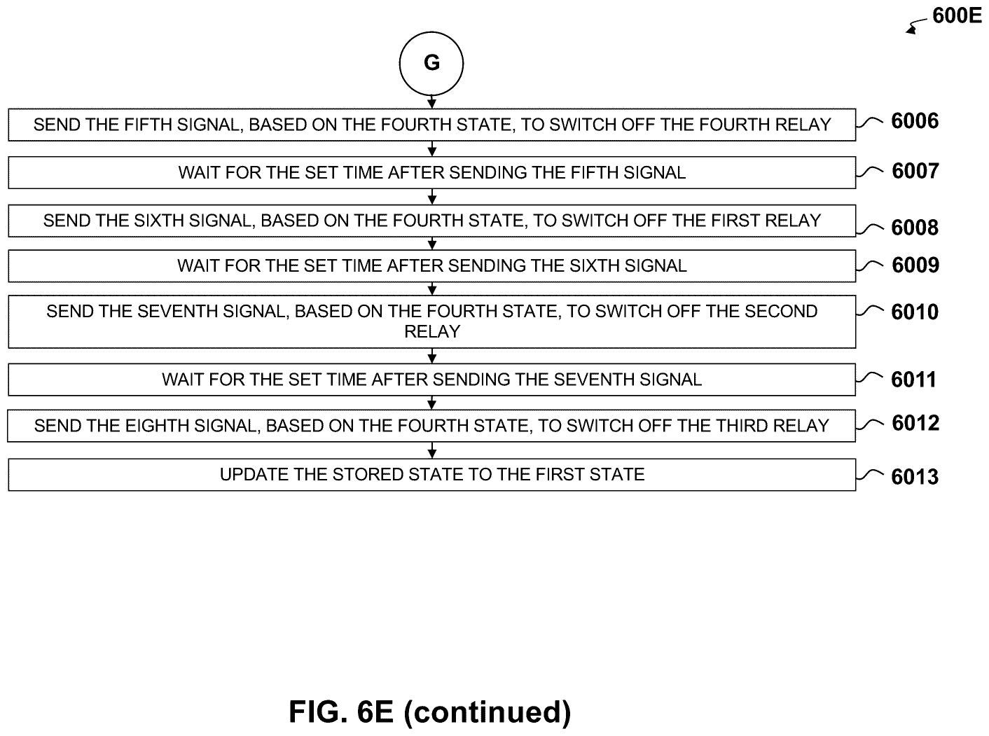

Referring to FIGS. 6A-6E, embodiments of a method implemented in a system for relay operation are disclosed. The method of turning multiple relays on/off disclosed herein may be implemented in a controller such as a digital controller, analog controller, microcontroller, microprocessor, etc. A memory device may be utilized to store relay information such as the on/off state of a relay, selected timing sequence for turning relays on/off, etc.

According to one embodiment, an example electrical system includes N relays such as Relay 1, Relay 2, . . . , Relay N. The relays are turned on/off in alternating sequence by the controller control signals after a set wait time for each relay, based on a sequence of N control states (e.g., stored in a memory device). Each control state specifies which relay is first to be turned on or first to be turned off, during a system power cycle. At the next power cycle, the next relay in the sequence is first to be turned on or off.

For example, when N=4, using a control state counter C, in control state C=1, in a power cycle upon receiving a power on signal to power the load from the power supply, Relay 1 is turned on first, and then subsequent relays are turned on in sequence after a set wait time has passed for each (i.e., after a set wait time Relay 2 is turned on second, after a set wait time Relay 3 is turned on third, after a set wait time Relay 4 is turned on fourth). Upon receiving a power off signal, Relay 1 is turned off first, and then subsequent relays are turned off in sequence after a set wait time has passed for each (i.e., after a set wait time Relay 2 is turned off second, after a set wait time Relay 3 is turned off third, after a set wait time Relay 4 is turned off fourth). The control state counter C is incremented by one.

For the next power cycle, in control state C=2, upon receiving a power on signal to power the load from the power supply, Relay 2 is turned on first, and then subsequent relays are turned on in sequence after a set wait time has passed for each (i.e., after a set wait time Relay 3 is turned on second, after a set wait time Relay 4 is turned on third, after a set wait time Relay 1 is turned on fourth). Upon receiving a power off signal Relay 2 is turned off first, and then subsequent relays are turned off in sequence after a set wait time has passed for each (i.e., after a set wait time Relay 3 is turned off second, after a set wait time Relay 4 is turned off third, after a set wait time Relay 1 is turned off fourth). The control state counter is incremented by one.

For the next power cycle, in control state C=3, upon receiving a power on signal to power the load from the power supply, Relay 3 is turned on first, and then subsequent relays are turned on in sequence after a set wait time has passed for each (i.e., after a set wait time Relay 4 is turned on second, after a set wait time Relay 1 is turned on third, after a set wait time Relay 2 is turned on fourth). Upon receiving a power off signal Relay 3 is turned off first, and then subsequent relays are turned off in sequence after a set wait time has passed for each (i.e., after a set wait time Relay 4 is turned off second, after a set wait time Relay 1 is turned off third, after a set wait time Relay 2 is turned off fourth). The control state counter is incremented by one.

For the next power cycle, in control state C=4, upon receiving a power on signal to power the load from the power supply, Relay 4 is turned on first, and then subsequent relays are turned on in sequence after a set wait time has passed for each (i.e., after a set wait time Relay 1 is turned on second, after a set wait time Relay 2 is turned on third, after a set wait time Relay 3 is turned on fourth). Upon receiving a power off signal Relay 4 is turned off first, and then subsequent relays are turned off in sequence after a set wait time has passed for each (i.e., after a set wait time Relay 1 is turned off second, after a set wait time Relay 2 is turned off third, after a set wait time Relay 3 is turned off fourth). When C=N, the control state counter is reset (i.e., C=1), and for the next power cycle the process repeats such that in control state C=1, upon receiving a power on signal, Relay 1 is turned on first, and then subsequent relays are turned on in sequence after a set wait time has passed for each (i.e., after a set wait time Relay 2 is turned on second, after a set wait time Relay 3 is turned on third, after a set wait time Relay 4 is turned on fourth). Upon receiving a power off signal, Relay 1 is turned off first, and then subsequent relays are turned off in sequence after a set wait time has passed for each (i.e., after a set wait time Relay 2 is turned off second, after a set wait time Relay 3 is turned off third, after a set wait time Relay 4 is turned off fourth). The control state counter C is incremented by one. And so on.

The state counter C cycles through counts 1, 2, . . . , N, 1, 2, . . . , N, 1, 2, . . . , N and so on. As such, for a power cycle in a control state C, upon receiving a power on signal, Relay C is turned on first, and then subsequent relays are turned on in sequence after a set wait time has passed for each, as described by the example above. Next, in control state C, upon receiving a power off signal, Relay C is turned off first, and then subsequent relays are turned off in sequence after a set wait time has passed for each, as described by the example above. When C=N, the control state counter C is reset (i.e., C=1), and for the next power cycle the process repeats.

FIG. 6A depicts a flow chart of a method embodiment 600 of turning two or more relays on/off in an electrical system. The method 600 may include storing, by a processor (e.g., controller, electronic control), a first state based on an order of two or more relays to be switched on (i.e., turned on, engaged) (step 602). The method 600 may then include sending, by the processor, one or more first control signals to switch on a relay of two or more relays based on the stored first state (step 604). The method 600 may then include waiting, by the processor, for a selected time after sending each first signal of the one or more first signals (step 606). The method 600 may then include updating, by the processor, the first state based on the order the one or more first signals were sent (step 608).

FIG. 6B depicts a flow chart of a method embodiment 601 of switching off two or more relays. The method 601 may include storing, by a processor, a second state based on an order of two or more relays to be switched off (step 610). The method 601 may then include sending, by the processor, one or more second signals to switch off (i.e., turn off) a relay of two or more relays based on the stored second state (step 612). The method 601 may then include waiting, by the processor, for a set time after sending each second signal of the one or more second signals (step 614). The method 601 may then include updating, by the processor, the second state based on the order the one or more second signals were sent (step 616). In some embodiments, the relays may be turned off in any order, simultaneously, or near simultaneously. Turning the relays off may not subject the relay to the stresses experienced while turning the relays on and may not otherwise shorten the life of the relays and the system using the relays.

As an example, Relay A may have a life cycle of 5,000 cycles and Relay B may have a life cycle of 8,000 cycles. Relay A is switched on first and a few milliseconds later Relay B is switched on. Next time the relays need to be turned on, the system switches on (turns on) Relay B first, waits a few milliseconds and then switches on Relay A. The same alternating process is used to switch each relay off. By using the disclosed system and method, it may now take 10,000 cycles for Relay A to reach the end of its useful life. That is, it takes twice as long for Relay A (2× the original life cycle of 5,000) or 10,000 cycles to reach the system's fail point.

For half of the cycles, one relay is switching into a Very Low/No Load which can slow down the amount of contact degradation. The disclosed system and method may be implemented in an existing charging system having an electrical control having two or more relays. In some embodiments, no additional hardware is needed.

A system that uses two relays for the transfer of AC Power to a load may have its usable life expectancy approximately doubled. In some embodiments, the usable life may be even more than two times the life of the relay that would have failed first.

The disclosed system and method may be applied across multiple industries and uses where two or more relays are switched on at the same or similar time. Other uses may include, but are not limited to, building lighting, motor controls, a three-phase industrial system with three relays, and a three-phase industrial system with four relays where a neutral is switched, also transistor/SCR/TRIACs/IBGTs/and the like.

FIG. 6C depicts a flow chart of a method embodiment 618 of switching on two relays. The method 618 may include storing a state, where the state comprises an order of two relays to be switched on (step 620). The method 618 may then include sending a first signal, based on the state, to switch on a first relay of two relays (step 622). The method 618 may then include waiting for a set time after sending the first signal (step 624). The method 618 may then include sending a second signal to switch on a second relay of the two relays (step 626). The method 618 may then include updating the state based on the order the first signal and the second signal were sent (step 628). The method 618 may then include sending the second signal, based on the state, to switch on the second relay of two relays (step 630). The method 618 may then include waiting for a set time after sending the second signal (step 632). The method 618 may then include sending the first signal to switch on the first relay of the two relays (step 634). The method 618 may then include updating the state based on the order the first signal and the second signal were sent (step 636). The method 618 may then repeat with step 622 such that the system alternates between turning the first relay on first and the second relay on first. While the method 618 is disclosed for two relays, the method may be used with any number of relays such that the order of the relays being turned on first is alternated.

FIG. 6D depicts a flow chart of a method embodiment 600D of switching on three relays. The method 600D may include storing a first state of N states where Nis a number of relays and where each state comprises an order of relays to be switched on (step 602D). In the first state, the method 600D may include sending first through third signals to turn on first through third relays (steps 604D-612D). In the first state, the method 600D may then include sending fourth through sixth signals to turn off the first through third relays (steps 614D-622D). The method 600D then updates the stored state to a second state (step 624D). The first relay may be relay A. The second relay may be relay B. The third relay may be relay C. The order of turning the relays on and off in the first state may be A, B, C and A, B, C. The order of turning the relays on and off in the second state may be B, C, A and B, C, A. The order of turning the relays on and off in the third state may be C, A, B and C, A, B. Other orders of turning the relays on and off for each state are possible and contemplated. The method 600D is shown with reference characters A and B connecting the flowchart steps.

The method 600D may include storing a first state of n states, where n is a number of relays, where each state comprises an order of relays to be switched on (step 602D). The method 600D may then include sending a first signal, based on the first state, to switch on a first relay (step 604D). The method 600D may then include waiting for a set time after sending the first signal (step 606D). The method 600D may then include sending a second signal, based on the first state, to switch on a second relay (step 608D). The method 600D may then include waiting for the set time after sending the second signal (step 610D). The method 600D may then include sending a third signal based on the first state, to switch on a third relay (step 612D). The method 600D may then include sending a fourth signal, based on the first state, to switch off the first relay (step 614D). The method 600D may then include waiting for a set time after sending the fourth signal (step 616D). The method 600D may then include sending a fifth signal, based on the first state, to switch off the second relay (step 618D). The method 600D may then include waiting for the set time after sending the fifth signal (step 620D). The method 600D may then include sending a sixth signal, based on the first state, to switch off the third relay (step 622D). The method 600D may then include updating the stored state to a second state (step 624D). The method 600D may then include sending the first signal, based on the second state, to switch on the second relay (step 626D). The method 600D may then include waiting for the set time after sending the first signal (step 628D). The method 600D may then include sending the second signal, based on the second state, to switch on the third relay (step 630D). The method 600D may then include waiting for the set time after sending the second signal (step 632D). The method 600D may then include sending the third signal, based on the second state, to switch on the first relay (step 634D). The method 600D may then include sending the fourth signal, based on the second state, to switch off the second relay (step 636D). The method 600D may then include waiting for a set time after sending the fourth signal (step 638D). The method 600D may then include sending the fifth signal, based on the second state, to switch off the third relay (step 640D). The method 600D may then include waiting for the set time after sending the fifth signal (step 642D). The method 600D may then include sending the sixth signal, based on the second state, to switch off the first relay (step 644D). The method 600D may then include updating the stored state to a third state (step 646D).

The method 600D may then include sending the first signal, based on the third state, to switch on the third relay (step 648D). The method 600D may then include waiting for the set time after sending the first signal (step 650D). The method 600D may then include sending the second signal, based on the third state, to switch on the first relay (step 652D). The method 600D may then include waiting for the set time after sending the second signal (step 654D). The method 600D may then include sending the third signal, based on the third state, to switch on the second relay (step 656D). The method 600D may then include sending the fourth signal, based on the third state, to switch off the third relay (step 658D). The method 600D may then include waiting for a set time after sending the fourth signal (step 660D). The method 600D may then include sending the fifth signal, based on the third state, to switch off the first relay (step 662D). The method 600D may then include waiting for the set time after sending the fifth signal (step 664D). The method 600D may then include sending the sixth signal, based on the third state, to switch off the second relay (step 666D). The method 600D may then include updating the stored state to the first state (step 668D).

FIG. 6E depicts a flow chart of a method embodiment 600E of switching on four relays. The first relay may be relay A. The second relay may be relay B. The third relay may be relay C. The fourth relay may be relay D. The order of turning the relays on and off in the first state may be A, B, C, D and A, B, C, D. The order of turning the relays on and off in the second state may be B, C, D, A and B, C, D, A. The order of turning the relays on and off in the third state may be C, D, A, B and C, D, A, B. The order of turning the relays on and off in the fourth state may be D, A, B, C, and D, A, B, C. Other orders of turning the relays on and off for each state are possible and contemplated. The method 600E is shown with reference characters A, B, D, D, E, F, and G connecting the flowchart steps.

The method 600E may include storing a first state of n states, where n is a number of relays, where each state comprises an order of relays to be switched on (step 601E). The method 600E may then include sending a first signal, based on the first state, to switch on a first relay (step 602E). The method 600E may then include waiting for a set time after sending the first signal (step 604E). The method 600E may then include sending a second signal, based on the first state, to switch on a second relay (step 608E). The method 600E may then include waiting for the set time after sending the second signal (step 610E). The method 600E may then include sending a third signal, based on the first state, to switch on a third relay (step 612E). The method 600E may then include waiting for the set time after sending the third signal (step 614E). The method 600E may then include sending a fourth signal, based on the first state, to switch on a fourth relay (step 616E). The method 600E may then include sending a fifth signal, based on the first state, to switch off the first relay (step 618E). The method 600E may then include waiting for the set time after sending the fifth signal (step 620E). The method 600E may then include sending a sixth signal, based on the first state, to switch off the second relay (step 622E). The method 600E may then include waiting for the set time after sending the sixth signal (step 624E). The method 600E may then include sending a seventh signal, based on the first state, to switch off the third relay (step 626E). The method 600E may then include waiting for the set time after sending the seventh signal (step 628E). The method 600E may then include sending an eighth signal, based on the first state, to switch off the fourth relay (step 630E). The method 600E may then include updating the stored state to a second state (step 632E). The method 600E may then include sending the first signal, based on the second state, to switch on the second relay (step 634E). The method 600E may then include waiting for the set time after sending the first signal (step 636E). The method 600E may then include sending the second signal, based on the second state, to switch on the third relay (step 638E). The method 600E may then include waiting for the set time after sending the second signal (step 640E). The method 600E may then include sending the third signal, based on the second state, to switch on the fourth relay (step 644E). The method 600E may then include waiting for the set time after sending the third signal (step 646E). The method 600E may then include sending the fourth signal, based on the second state, to switch on the first relay (step 648E). The method 600E may then include sending the fifth signal, based on the second state, to switch off the second relay (step 650E). The method 600E may then include waiting for the set time after sending the fifth signal (step 652E). The method 600E may then include sending the sixth signal, based on the second state, to switch off the third relay (step 654E). The method 600E may then include waiting for the set time after sending the sixth signal (step 656E). The method 600E may then include sending the seventh signal, based on the second state, to switch off the fourth relay (step 658E). The method 600E may then include waiting for the set time after sending the seventh signal (step 660E). The method 600E may then include sending the eighth signal, based on the second state, to switch off the first relay (step 662E). The method 600E may then include updating the stored state to a third state (664E). The method 600E may then include sending the first signal, based on the third state, to switch on the third relay (step 666E). The method 600E may then include waiting for the set time after sending the first signal (step 668E). The method 600E may then include sending the second signal, based on the third state, to switch on the fourth relay (step 670E). The method 600E may then include waiting for the set time after sending the second signal (step 672E). The method 600E may then include sending the third signal, based on the third state, to switch on the first relay (step 674E). The method 600E may then include waiting for the set time after sending the third signal (step 676E). The method 600E may then include sending the fourth signal, based on the third state, to switch on the second relay (step 678E). The method 600E may then include sending the fifth signal, based on the third state, to switch off the third relay (step 680E). The method 600E may then include waiting for the set time after sending the fifth signal (step 682E). The method 600E may then include sending the sixth signal, based on the third state, to switch off the fourth relay (684E). The method 600E may then include waiting for the set time after sending the sixth signal (step 686E). The method 600E may then include sending the seventh signal, based on the third state, to switch off the first relay (step 688E).

The method 600E may then include waiting for the set time after sending the seventh signal (step 690E). The method 600E may then include sending the eighth signal, based on the third state, to switch off the second relay (step 692E). The method 600E may then include updating the stored state to a fourth state (step 694E). The method 600E may then include sending the first signal, based on the fourth state, to switch on the fourth relay (step 696E). The method 600E may then include waiting for the set time after sending the first signal (step 698E). The method 600E may then include sending the second signal, based on the fourth state, to switch on the first relay (step 6001). The method 600E may then include waiting for the set time after sending the second signal (step 6002). The method 600E may then include sending the third signal, based on the fourth state, to switch on the second relay (step 6003). The method 600E may then include waiting for the set time after sending the third signal (step 6004). The method 600E may then include sending the fourth signal, based on the fourth state, to switch on the third relay (step 6005). The method 600E may then include sending the fifth signal, based on the fourth state, to switch off the fourth relay (step 6006). The method 600E may then include waiting for the set time after sending the fifth signal (step 6007). The method 600E may then include sending the sixth signal, based on the fourth state, to switch off the first relay (step 6008). The method 600E may then include waiting for the set time after sending the sixth signal (step 6009). The method 600E may then include sending the seventh signal, based on the fourth state, to switch off the second relay (step 6010). The method 600E may then include waiting for the set time after sending the seventh signal (step 6011). The method 600E may then include sending the eighth signal, based on the fourth state, to switch off the third relay (step 6012). The method 600E may then include updating the stored state to the first state (step 6013).

Embodiments disclosed herein comprise systems, devices, and methods including: an electronic device configured to store the last known operational state of electrical relays in an electrical system, wherein the electronic device is in communication with two or more relays, and the electronic device is configured to: store a first state based on an order of two or more relays to be turned on; send one or more first signals to switch on a relay of two or more relays based on the stored first state; wait for a set time after sending each first signal of the one or more first signals; and update the first state based on the number of relays in the system and the order of signals that were sent. According to one embodiment, the actuation controls (energizing of the relay coils) is performed such that the actuation of the relays being alternated would be of benefit.

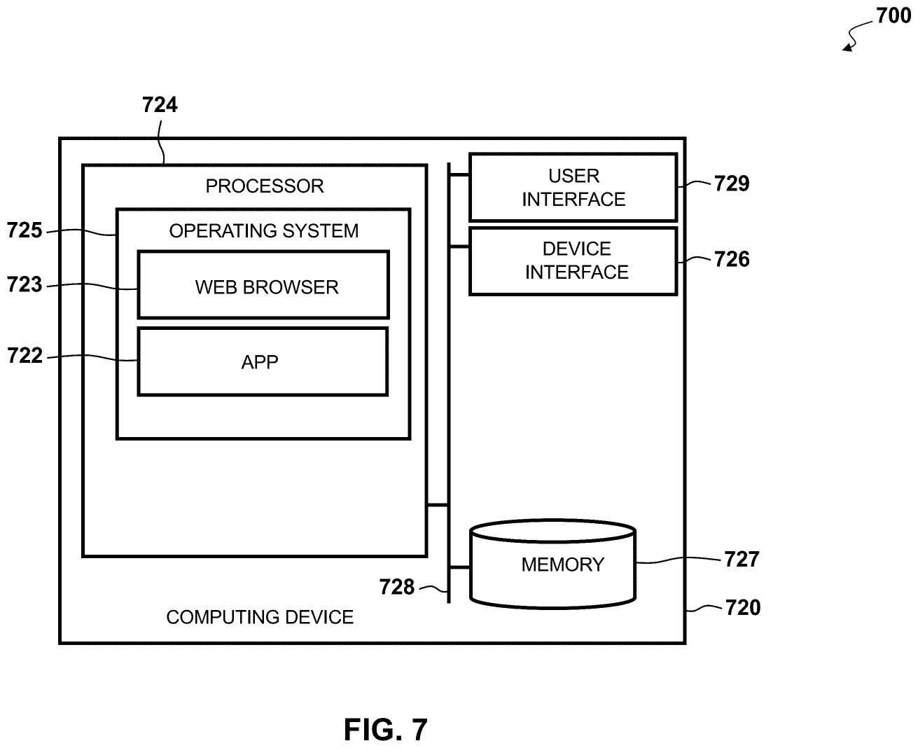

FIG. 7 illustrates an example of a top-level functional block diagram of a computing device embodiment 700. The example operating environment is shown as a computing device 720 comprising a processor 724, such as a central processing unit (CPU), addressable memory 727, an external device interface 726, e.g., an optional universal serial bus port and related processing, and/or an Ethernet port and related processing, and an optional user interface 729, e.g., an array of status lights and one or more toggle switches, and/or a display, and/or a keyboard and/or a pointer-mouse system and/or a touch screen. Optionally, the addressable memory may include any type of computer-readable media that can store data accessible by the computing device 720, such as magnetic hard and floppy disk drives, optical disk drives, magnetic cassettes, tape drives, flash memory cards, digital video disks (DVDs), Bernoulli cartridges, RAMs, ROMs, smart cards, etc. Indeed, any medium for storing or transmitting computer-readable instructions and data may be employed, including a connection port to or node on a network, such as a LAN, WAN, or the Internet. These elements may be in communication with one another via a data bus 728. In some embodiments, via an operating system 725 such as one supporting a web browser 723 and applications 722, the processor 724 may be configured to execute steps of a process establishing a communication channel and processing according to the embodiments described above.

The disclosed method and system allow for the detection of a status of each relay, and indicate whether the relay is operating correctly, when there is a fault condition, such as when relay contacts are degraded or welded together. In one example, reflector may be added onto one of the relay contacts to reflect a signal from an emitter. A detector may receive the reflected signal to determine the status of the relay.

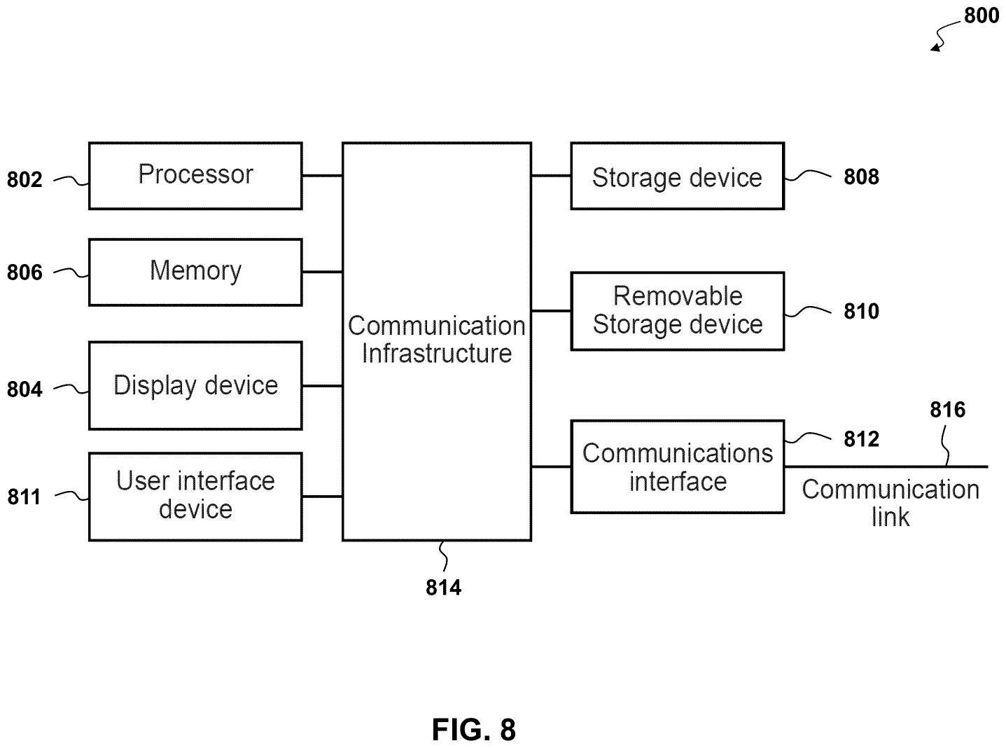

FIG. 8 is a high-level block diagram 800 showing a computing system comprising a computer system useful for implementing an embodiment of the system and process, disclosed herein. Embodiments of the system may be implemented in different computing environments. The computer system includes one or more processors 802, and can further include an electronic display device 804 (e.g., for displaying graphics, text, and other data), a main memory 806 (e.g., random access memory (RAM)), storage device 808, a removable storage device 810 (e.g., removable storage drive, a removable memory module, a magnetic tape drive, an optical disk drive, a computer readable medium having stored therein computer software and/or data), user interface device 811 (e.g., keyboard, touch screen, keypad, pointing device), and a communication interface 812 (e.g., modem, a network interface (such as an Ethernet card), a communications port, or a PCMCIA slot and card). The communication interface 812 allows software and data to be transferred between the computer system and external devices. The system further includes a communications infrastructure 814 (e.g., a communications bus, cross-over bar, or network) to which the aforementioned devices/modules are connected as shown.

Information transferred via communications interface 814 may be in the form of signals such as electronic, electromagnetic, optical, or other signals capable of being received by a communications interface 814, via a communication link 816 that carries signals and may be implemented using wire or cable, fiber optics, a phone line, a cellular/mobile phone link, a radio frequency (RF) link, and/or other communication channels. Computer program instructions representing the block diagram and/or flowcharts herein may be loaded onto a computer, programmable data processing apparatus, or processing devices to cause a series of operations performed thereon to produce a computer-implemented process.

Embodiments have been described with reference to flowchart illustrations and/or block diagrams of methods, apparatus (systems), and computer program products according to embodiments. Each block of such illustrations/diagrams, or combinations thereof, can be implemented by computer program instructions. The computer program instructions when provided to a processor produce a machine, such that the instructions, which execute via the processor, create means for implementing the functions/operations specified in the flowchart and/or block diagram. Each block in the flowchart/block diagrams may represent a hardware and/or software module or logic-implementing embodiments. In alternative implementations, the functions noted in the blocks may occur out of the order noted in the figures, concurrently, etc.

Computer programs (i.e., computer control logic) are stored in main memory and/or secondary memory. Computer programs may also be received via a communications interface 812. Such computer programs, when executed, enable the computer system to perform the features of the embodiments as discussed herein. In particular, the computer programs, when executed, enable the processor and/or multi-core processor to perform the features of the computer system. Such computer programs represent controllers of the computer system.

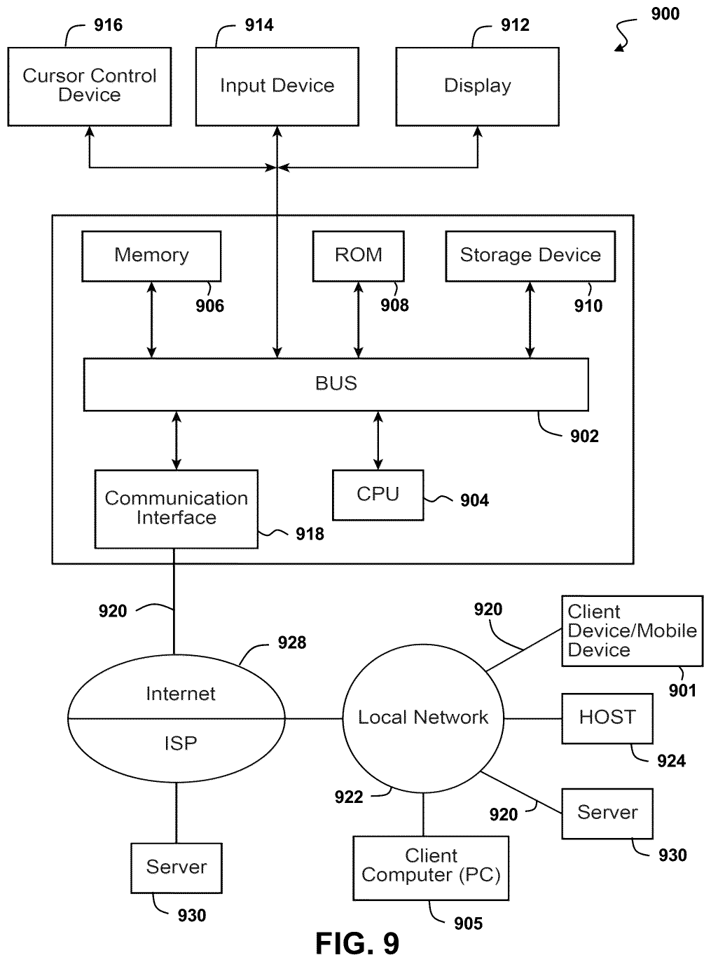

FIG. 9 shows a block diagram of an example system 900 in which an embodiment may be implemented. The system 900 includes one or more client devices 901 such as consumer electronics devices, connected to one or more server computing systems 930. A server 930 includes a bus 902 or other communication mechanism for communicating information, and a processor (CPU) 904 coupled with the bus 902 for processing information. The server 930 also includes a main memory 906, such as a random-access memory (RAM) or other dynamic storage device, coupled to the bus 902 for storing information and instructions to be executed by the processor 904. The main memory 906 also may be used for storing temporary variables or other intermediate information during execution or instructions to be executed by the processor 904. The server computer system 930 further includes a read-only memory (ROM) 908 or other static storage devices coupled to the bus 902 for storing static information and instructions for the processor 904. A storage device 910, such as a magnetic disk or optical disk, is provided and coupled to the bus 902 for storing information and instructions. The bus 902 may contain, for example, thirty-two address lines for addressing video memory or main memory 906. The bus 902 can also include, for example, a 32-bit data bus for transferring data between and among the components, such as the CPU 904, the main memory 906, video memory, and the storage 910. Alternatively, multiplex data/address lines may be used instead of separate data and address lines.

The server 930 may be coupled via the bus 902 to a display 912 for displaying information to a computer user. An input device 914, including alphanumeric and other keys, is coupled to the bus 902 for communicating information and command selections to the processor 904. Another type or user input device comprises cursor control 916, such as a mouse, a trackball, or cursor direction keys for communicating direction information and command selections to the processor 904 and for controlling cursor movement on the display 912.

According to one embodiment, the functions are performed by the processor 904 executing one or more sequences of one or more instructions contained in the main memory 906. Such instructions may be read into the main memory 906 from another computer-readable medium, such as the storage device 910. Execution of the sequences of instructions contained in the main memory 906 causes the processor 904 to perform the process steps described herein. One or more processors in a multi-processing arrangement may also be employed to execute the sequences of instructions contained in the main memory 906. In alternative embodiments, hard-wired circuitry may be used in place of or in combination with software instructions to implement the embodiments. Thus, embodiments are not limited to any specific combination of hardware circuitry and software.

The terms “computer program medium,” “computer usable medium,” “computer readable medium”, and “computer program product,” are used to generally refer to media such as main memory, secondary memory, removable storage drive, a hard disk installed in a hard disk drive, and signals. These computer program products are means for providing software to the computer system. The computer-readable medium allows the computer system to read data, instructions, messages or message packets, and other computer-readable information from the computer-readable medium. The computer-readable medium, for example, may include non-volatile memory, such as a floppy disk, ROM, flash memory, disk drive memory, a CD-ROM, and other permanent storage. It is useful, for example, for transporting information, such as data and computer instructions, between computer systems. Furthermore, the computer-readable medium may comprise computer-readable information in a transitory state medium such as a network link and/or a network interface, including a wired network or a wireless network that allows a computer to read such computer-readable information. Computer programs (also called computer control logic) are stored in main memory and/or secondary memory. Computer programs may also be received via a communications interface. Such computer programs, when executed, enable the computer system to perform the features of the embodiments as discussed herein. In particular, the computer programs, when executed, enable the processor multi-core processor to perform the features of the computer system. Accordingly, such computer programs represent controllers of the computer system.

Generally, the term “computer-readable medium” as used herein refers to any medium that participated in providing instructions to the processor 904 for execution. Such a medium may take many forms, including but not limited to, non-volatile media, volatile media, and transmission media. Non-volatile media includes, for example, optical or magnetic disks, such as the storage device 910. Volatile media includes dynamic memory, such as the main memory 906. Transmission media includes coaxial cables, copper wire, and fiber optics, including the wires that comprise the bus 902. Transmission media can also take the form of acoustic or light waves, such as those generated during radio wave and infrared data communications.

Common forms of computer-readable media include, for example, a floppy disk, a flexible disk, hard disk, magnetic tape, or any other magnetic medium, a CD-ROM, any other optical medium, punch cards, paper tape, any other physical medium with patterns of holes, a RAM, a PROM, an EPROM, a FLASH-EPROM, any other memory chip or cartridge, a carrier wave as described hereinafter, or any other medium from which a computer can read.

Various forms of computer-readable media may be involved in carrying one or more sequences of one or more instructions to the processor 904 for execution. For example, the instructions may initially be carried on a magnetic disk of a remote computer. The remote computer can load the instructions into its dynamic memory and send the instructions over a telephone line using a modem. A modem local to the server 930 can receive the data on the telephone line and use an infrared transmitter to convert the data to an infrared signal. An infrared detector coupled to the bus 902 can receive the data carried in the infrared signal and place the data on the bus 902. The bus 902 carries the data to the main memory 906, from which the processor 904 retrieves and executes the instructions. The instructions received from the main memory 906 may optionally be stored on the storage device 910 either before or after execution by the processor 904.

The server 930 also includes a communication interface 918 coupled to the bus 902. The communication interface 918 provides a two-way data communication coupling to a network link 920 that is connected to the worldwide packet data communication network now commonly referred to as the Internet 928. The Internet 928 uses electrical, electromagnetic, or optical signals that carry digital data streams. The signals through the various networks and the signals on the network link 920 and through the communication interface 918, which carry the digital data to and from the server 930, are example forms of carrier waves transporting the information.

In another embodiment of the server 930, the communication interface 918 is connected to a network 922 via a communication link 920. For example, the communication interface 918 may be an integrated services digital network (ISDN) card or a modem to provide a data communication connection to a corresponding type of telephone line, which can comprise part of the network link 920. As another example, the communication interface 918 may be a local area network (LAN) card to provide a data communication connection to a compatible LAN. Wireless links may also be implemented. In any such implementation, the communication interface 918 sends and receives electrical electromagnetic or optical signals that carry digital data streams representing various types of information.

The network link 920 typically provides data communication through one or more networks to other data devices. For example, the network link 920 may provide a connection through the local network 922 to a host computer 924 or to data equipment operated by an Internet Service Provider (ISP). The ISP in turn provides data communication services through the Internet 928. The local network 922 and the Internet 928 both use electrical, electromagnetic, or optical signals that carry digital data streams. The signals through the various networks and the signals on the network link 920 and through the communication interface 918, which carry the digital data to and from the server 930, are example forms of carrier waves transporting the information.

The server 930 can send/receive messages and data, including e-mail, and program code, through the network, the network link 920, and the communication interface 918. Further, the communication interface 918 can comprise a USB/Tuner and the network link 920 may be an antenna or cable for connecting the server 930 to a cable provider, satellite provider, or other terrestrial transmission system for receiving messages, data, and program code from another source.

The example versions of the embodiments described herein may be implemented as logical operations in a distributed processing system such as the system 900 including the servers 930. The logical operations of the embodiments may be implemented as a sequence of steps executing in the server 930, and as interconnected machine modules within the system 900. The implementation is a matter of choice and can depend on the performance of the system 900 implementing the embodiments. As such, the logical operations constituting said example versions of the embodiments are referred to for example, as operations, steps, or modules.

Similar to a server 930 described above, a client device 901 can include a processor, memory, storage device, display, input device, and communication interface (e.g., e-mail interface) for connecting the client device to the Internet 928, the ISP, or LAN 922, for communication with the servers 930. The system 900 can further include computers (e.g., personal computers, computing nodes) 905 operating in the same manner as client devices 901, where a user can utilize one or more computers 905 to manage data in the server 930.

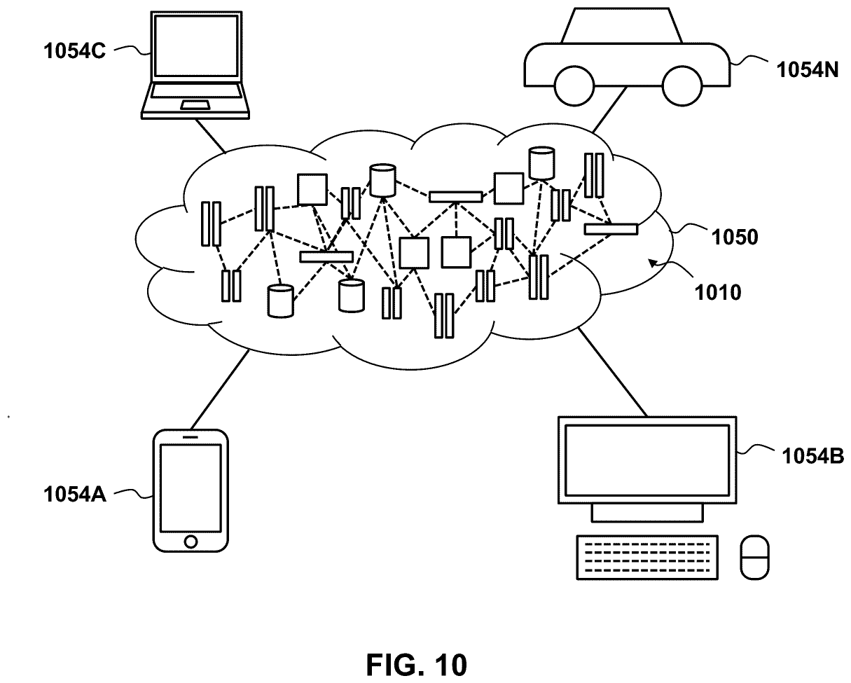

Referring now to FIG. 10, illustrative cloud computing environment 1050 is depicted. As shown, cloud computing environment 1050 comprises one or more cloud computing nodes 1010 with which local computing devices used by cloud consumers, such as, for example, personal digital assistant (PDA), smartphone, smart watch, set-top box, video game system, tablet, mobile computing device, or cellular telephone 1054A, desktop computer 1054B, laptop computer 1054C, and/or automobile computer system 1054N may communicate. Nodes 1010 may communicate with one another. They may be grouped (not shown) physically or virtually, in one or more networks, such as Private, Community, Public, or Hybrid clouds as described hereinabove, or a combination thereof. This allows cloud computing environment 1050 to offer infrastructure, platforms, and/or software as services for which a cloud consumer does not need to maintain resources on a local computing device. It is understood that the types of computing devices 1054A-N shown in FIG. 10 are intended to be illustrative only and that computing nodes 1010 and cloud computing environment 1050 can communicate with any type of computerized device over any type of network and/or network addressable connection (e.g., using a web browser).

It is contemplated that various combinations and/or sub-combinations of the specific features and aspects of the above embodiments may be made and still fall within the scope of the invention. Accordingly, it should be understood that various features and aspects of the disclosed embodiments may be combined with or substituted for one another in order to form varying modes of the disclosed invention. Further, it is intended that the scope of the present invention herein disclosed by way of examples should not be limited by the particular disclosed embodiments described above.

What is claimed is:

1. A system comprising:
a processor having addressable memory, the processor in communication with two or more relays, wherein the processor is configured to:
store a first state based on an order of two or more relays to be switched on;
send one or more first signals to switch on a relay of two or more relays based on the stored first state;
wait for a set time after sending each first signal of the one or more first signals; and
update the first state based on the order the one or more first signals were sent.

2. The system of claim 1, wherein the processor is further configured to:
store a second state based on an order of two or more relays to be switched off;
send one or more second signals to switch off a relay of two or more relays based on the stored second state;
wait for a set time after sending each second signal of the one or more second signals; and
update the second state based on the order the one or more second signals were sent.

3. The system of claim 1, wherein the set time is greater than an operating time of each relay of the two or more relays.

3. The system of claim 1, wherein the set time is based on a transfer time of the two or more relays and a system power cycle time.

4. The system of claim 1, wherein the order of the two or more relays to be switched on is in a variable sequence determined by the first state.

5. The system of claim 1, wherein the two or more relays are in an electric vehicle supply equipment (EVSE).

6. The system of claim 1, wherein the processor is further configured to:
check a status of the two or more relays after the one or more first signals were sent.

7. The system of claim 1, wherein the stored first state is configured to vary which relay of the two or more relays is turned on as a first relay to be turned on, and wherein the stored first state is configured to reduce early degradation of a relay of the two or more relays in relation to other relays of the two or more relays.

8. The system of claim 1, wherein the two or more relays comprise two relays, wherein a first first signal of the one or more first signals is configured to turn on a first relay of the two or more relays based on the stored first state, wherein a second first signal of the one or more first signals is configured to turn on a second relay of the two or more relays based on the stored first state.

9. The system of claim 8, wherein the first first signal of the one or more first signals is configured to turn on the second relay of the two or more relays based on the updated first state, and wherein the second first signal of the one or more first signals is configured to turn on the first relay of the two or more relays based on the updated first state.

10. A system for controlling a plurality of electrical switches, each electrical switch having two or more operational states and responsive to control signals for changing between operational states, the system comprising:
a controller configured to generate control signals to selectively change the operational state of one or more of the electrical switches based on at least one of: a selected timing and a selected sequence;
wherein the selective changing of the operational state of the one or more of the electrical switches is configured to reduce early degradation of the one or more of the electrical switches in relation to said plurality of electrical switches.

11. The system of claim 10, wherein the controller is further configured to generate control signals to selectively change the operational state of one or more of the electrical switches based on a selected timing as a function of the operational characteristics of one or more of the electrical switches.

12. The system of claim 11, wherein the controller is further configured to selectively change the operational state of one or more of the electrical switches based on a selected timing as a function of said operational characteristics including one or more of: power cycle time and switch transfer time.

13. The system of claim 10, wherein the controller is further configured to generate control signals to selectively change the operational state of one or more of the electrical switches in a variable sequence.

14. The system of claim 13, wherein the controller is further configured to generate control signals to selectively change the operational state of one or more of the electrical switches in a variable sequence based on selected timing as a function of one or more of: power cycle time and switch transfer time.

15. The system of claim 10, wherein the controller is configured to generate control signals to change the operational state of one or more of the electrical switches in an alternating sequence.

16. The system of claim 15, wherein the controller is further configured to change the operational state of one or more of the electrical switches in an alternating sequence based on selected timing as a function of one or more of: switch transfer time and system power cycle time.

17. The system of claim 10, wherein the controller is further configured to change the operational state of each of the electrical switches based on a selected timing and selected sequence to prevent one or more of the electrical switches from early degradation in relation to the other electrical switches in the system.

18. A system comprising:
a plurality of electrical switches, each electrical switch having two or more operational states and responsive to control signals for changing between operational states;
a controller configured to generate control signals to selectively change the operational state of one or more of the electrical switches based on at least one of: a selected timing and a selected sequence,
to reduce early degradation of one or more of the electrical switches in relation to said plurality of electrical switches.

19. The system of claim 18, further comprising:
N relays;
a state counter C that cycles through counts 1, 2, . . . , N, 1, 2, . . . , N, 1, 2, . . . , N,
wherein the controller is further configured such that in a power cycle:
in a control state C, upon receiving a power on signal, a relay C is turned on first, and then subsequent relays are turned on in sequence after a set wait time has passed for each delay;
in the control state C, upon receiving a power off signal, relay C is turned off first, and then subsequent relays are turned off in sequence after a set wait time has passed for each;
the state counter is incremented by one, such that when C=N, the state counter C is reset to 1.

20. The system of claim 19, wherein the set wait time is a function of at least one of: relay transfer time and system power cycle time.
